(19) United States
(12) Patent Application Publication
(10) Pub. No.: US 2011/0233967 A1
(43) Pub. Date: Sep. 29, 2011

(54) FLOOR PANEL STRUCTURE OF VEHICLE

(75) Inventors: Tomonori OHTSUBO, Hiroshima (JP); Shingo KUNIHIRO, Hiroshima (JP); Asami IWAMOTO, Hiroshima (JP); Kohji OHTA, Hiroshima (JP); Yoji YATSUSHIRO, Hiroshima (JP); Masayoshi HORIUE, Hiroshima (JP); Hiroki UEMURA, Hiroshima (JP)

(73) Assignee: MAZDA MOTOR CORPORATION, Hiroshima (JP)

(21) Appl. No.: 13/013,575

(22) Filed: Jan. 25, 2011

(30) Foreign Application Priority Data
Mar. 26, 2010 (JP) 2010-073276

(51) Int. Cl. B62D 25/20

(52) U.S. Cl. 296/193.07; 296/75

(57) ABSTRACT

In a vehicle in which a driver's seat is provided on a floor panel and an operational pedal, such as a brake pedal, is provided in front of the driver's seat, a slant floor portion is provided in an area of the floor panel where a heel of a driver pressing the operational pedal is placed. This slant floor portion slants with a specified slant degree in such a manner that its front portion is positioned at a higher level than its rear portion. An interference avoidance portion which is comprised of a horizontal face portion is provided in front of the slant floor portion. This interference avoidance portion has a slant degree which is smaller than the specified slant degree of the slant floor portion so as to avoid interference with the heel of the driver's foot.

### BACKGROUND OF THE INVENTION

The present invention relates to a floor panel structure of a vehicle in which a driver's seat is provided on a floor panel forming a bottom portion of a vehicle room and an operational pedal is provided in front of the driver's seat.

Conventionally, a driving position adjusting device, which comprises a seat position adjusting means for adjusting a seat sitting-face position, a floor-panel position adjusting means for adjusting a vertical position of a floor panel (movable floor) on which a leg of a driver operating a pedal is placed, and a driving position adjusting means for operating these both means, is known as disclosed in Japanese Patent Laid-Open Publication No. 2005-145405, for example. According to this driving position adjusting device, both setting a proper driving position and securing a proper front view can be provided regardless of the size of a passenger's body. Further, even if the amount of adjustment of the seat's longitudinal position is rather small, the proper driving position can be obtained, and a proper pedal operation can be secured by adjusting the floor height.

Further, Japanese Patent Laid-Open Publication No. 2009-208638 discloses a floor structure of a driver's seat of a vehicle, which comprises a brake pedal and an acceleration pedal, which are pressed by a pedal operational foot of a driver seated in a driver's seat, are arranged at a front portion of a vehicle room, comprising a heel placement area where a heel of the pedal operational foot is placed, which is provided at a position on a floor which is in back of a pressing point of the brake pedal or the acceleration pedal, and a heel placement portion provided in part of the above-described heel placement area, the heel placement portion having an upper face which protrudes above the other area, wherein the longitudinal length of a first heel placement portion positioned in back of the brake pedal is set to be shorter than that of a second heel placement portion positioned in back of the acceleration pedal. According to this floor structure, the driving position can be adjusted easily and properly with a simple structure, so that the driver can operate the operational pedal properly.

According to the driving position adjusting device of a vehicle disclosed in the above-described first publication, since the driver seated in the driver's seat can move the driver's seat longitudinally in accordance with the height of the driver and adjust a vertical position and a slant angle of a seat cushion accordingly by using the seat position adjusting means, a proper pressing operation of the operational pedal, such as the acceleration pedal or the brake pedal, can be achieved, maintaining a comfortable sitting position of the driver in the driver's seat, and also the driver's sitting position can be adjusted so as to obtain an appropriate front view. Moreover, since the vertical position of the movable floor is adjustable by the floor-panel position adjusting means depending on the driver being changed to another person having a different height, accordingly different foot length, sole length, or the like, the pressing characteristics of the operational pedal is properly adjustable so that a ball of the pedal operational foot can properly contact a pedal surface of the operational pedal in a state where the heel of the driver's foot is placed on the floor panel.

However, in case the longitudinal position of the driver's seat and the vertical position and the slant angle of the seat cushion are adjustable with the seat position adjusting means and the vertical position of the movable floor panel is adjustable with the floor-panel position adjusting means, there is a problem in that the structure of these means may become so complex that the manufacturing costs would be too high and so on. In particular, since the above-described floor-panel position adjusting means needs to be arranged in a narrow gap formed between the movable floor and the floor panel located below this movable floor, there is a problem in that it would be difficult to secure such a large space enough to arrange this means. Meanwhile, even in case the vertical position is adjusted to an appropriate height by the floor-panel position adjusting means, since the pedal operation by the driver and the like may change in accordance with adjustments of the position and the angle of the driver's seat with the seat position adjusting means, it would be so difficult that all of the position and angle of the driver's seat and the vertical position of the movable floor panel are adjusted to their appropriate values.

Meanwhile, according to the floor structure of a driver's seat disclosed in the above-described second publication, since the ball of the operational pedal's foot can be made properly contact the pressing point of the acceleration pedal, maintaining an angle of the foot's ankle and an inclination angle of a foot's sole at appropriate angles, respectively, in a state in which a small driver seated in the driver's seat places its heel on the above-described first heel placement portion, it can be effectively prevented that a delicate pedal operation is hindered by the pressing operation of the acceleration pedal which is conducted in a state in which the heel of the pedal operational foot is away from the floor surface. Further, in case of a tall driver, the pressing changing operation between the acceleration pedal and the brake pedal and the like can be conducted in a state in which the heel of the pedal operational foot is located at a specified portion which is positioned in back of a rear end portion of the above-described first heel placement portion and beside the above-described second heel placement portion. Thereby, it can be effectively prevented that the above-described pressing changing operation is hindered by the first and second heel placement portions.

However, in case the upper surface of the heel placement area where the heel of the pedal operational foot is placed is configured to slant with a constant angle in such a manner that its upper portion is positioned at the higher level than its rear portion, the heel of the pedal operational foot moves forwardly and comes to be pressed against the upper surface of the heel placement area having the above-described slant surface when a driving state in which the operational pedal is pressed so as to delicately adjust the pressing amount with the driver's heel placed on the heel displacement area is changed to a quick pedal operational state in which the pressing amount of the operational pedal is increased promptly. This may cause a situation where the driver would have bad feelings and the like. Accordingly, there still exists some room to improve the pedal operation.

### SUMMARY OF THE INVENTION

The present invention has been devised in view of the above-described matters, and an object of the present invention is to provide a floor panel structure of a vehicle which can effectively improve the pedal operation with a simple structure.

According to the present invention, there is provided a floor panel structure of a vehicle, in which a driver's seat is provided on a floor panel forming a bottom portion of a vehicle room and an operational pedal is provided in front of the driver's seat, comprising a slant floor portion provided in an area of the floor panel on which a heel of a foot of a driver pressing the operational pedal is placed, the slant floor portion slanting with a specified slant degree in such a manner that a front portion thereof is positioned at a higher level than a rear portion thereof, and an interference avoidance portion provided in front of the slant floor portion, the interference avoidance portion having a slant degree which is smaller than the specified slant degree of the slant floor portion so as to avoid interference with the heel of the driver's foot.

According to the present invention, since the above-described slant floor portion is provided, even in case of the small driver having the short sole length, the ball of the pedal operational foot can be made contact the appropriate position of the operational pedal, maintaining the ankle's angle and the sole's inclination angle at the appropriate angles, in a state in which the heel is placed at a relatively high position on the slant floor portion. Thereby, the pedal pressing operation can be conducted easily and properly. Further, since the interference avoidance portion is provided, it can be prevented that the driver has the bad feelings which may be caused by the improper pressing of the driver's heel against the upper surface of the slant floor portion, for example, when a normal operating state in which the operational pedal is pressed so as to delicately adjust the pressing amount is changed to a quick operational state in which the pressing amount of the operational pedal is increased promptly. Thereby, the proper pedal operation can be secured.

According to an embodiment of the present invention, the interference avoidance portion has a substantially-flat upper face. Thereby, the above-described prevention of the driver having the bad feelings can be achieved effectively with a simpler structure.

According to another embodiment of the present invention, the interference avoidance portion has an upper face which slants in such a manner that a front portion thereof is positioned at a lower level than a rear portion thereof. Thereby, it can be prevented more effectively that the driver has the bad feelings which may be caused by the improper pressing of the driver's heel against the floor surface when the normal operation state in which the operational pedal is normally operated is changed to the quick operation state in which the operational pedal is pressed promptly.

According to another embodiment of the present invention, the slant floor portion has a steeper slant area on the side of the operational pedal thereof than that on the side of the driver's seat thereof. Thereby, even in case of the small driver having the short sole length, the ball of the pedal operational foot can be made contact the appropriate position of the operational pedal, maintaining the ankle's angle and the sole's inclination angle at the appropriate angles, in a state in which the heel is placed at the relatively high position, by placing the heel of the pedal operational foot at a specified position on the slant floor portion which is located closer to the operational pedal. Accordingly, the pressing operation can be achieved easily and properly.

According to another embodiment of the present invention, a slant angle of a portion on the side of the operational pedal of the slant floor portion is set within a range of 15° to 25°, and a slant angle of a portion on the side of the driver's seat of the slant floor portion is set within a range of 5° to 15°. Thereby, since the slant angle of the portion on the side of the operational pedal of the slant floor portion is set within the range of 15° to 25°, the short driver can conduct the pedal operation properly keeping the heel placed on the portion on the side of the operational pedal of the slant floor portion, effectively preventing the heel from slipping down during the pedal operation. Meanwhile, since the slant angle of the portion on the side of the driver's seat of the slant floor portion is set within the range of 5° to 15°, the slide resistance of the heel of the tall driver moving forwardly during the pedal operation can be effectively decreased, and also it can be effectively prevented that the heel of the average-sized driver having a slightly shorter sole's length than the tall driver comes to be away from the floor surface so that the delicate pedal operation is hindered.

According to another embodiment of the present invention, between a portion on the side of the driver's seat of the slant floor portion and a portion on the side of the operational pedal of the slant floor portion is provided a middle area where a slant angle increases gradually from an angle corresponding to a slant angle of the portion on the side of the driver's seat to another angle corresponding to a slant angle of the portion on the side of the operational pedal. Thereby, since the above-described middle area is provided, when the average-sized driver or the like adjust the heel height at its appropriate level by moving the heel longitudinally on the middle area, this adjustment can be conducted properly without making the driver from having bad feelings.

According to another embodiment of the present invention, the operational pedal is an acceleration pedal which comprises a pedal base portion fixed to the floor panel and a pedal body pivotally supported at a pivotal portion which is formed at the pedal base portion. Thereby, since the acceleration pedal is a so-called organ type of acceleration pedal, the acceleration pedal can be properly pressed with a simple structure regardless of the body size of the driver seated in the driver's seat.

According to another embodiment of the present invention, the operational pedal is a brake pedal which comprises a pivotal portion provided at an upper portion thereof and a pressing operational portion pivotally supported at the pivotal portion. Thereby, since the brake pedal is a so-called hanging type of brake pedal, the brake pedal can be properly pressed with a simple structure regardless of the body size of the driver seated in the driver's seat.

According to another embodiment of the present invention, the operational pedal comprises an acceleration pedal and a brake pedal which are provided side by side. Thereby, it can be prevented that the driver has the bad feelings which may be caused by the improper pressing of the driver's heel against the upper surface of the slant floor portion when the normal driving state in which the acceleration pedal is operated is changed to the quick braking state in which the brake pedal is pressed promptly. Thereby, the proper pedal operation can be secured.

According to another embodiment of the present invention, the slant floor portion comprises a first portion provided in the area of the floor panel on which the heel of the foot of the driver pressing the acceleration pedal is placed, and a second portion provided in the area of the floor panel on which the heel of the foot of the driver pressing the brake pedal is placed, the first portion having a steeper slant area on the side of the acceleration pedal than that on the side of the driver's seat thereof, and the second portion having an area with a constant slant which covers a substantially whole area thereof. Herein, there may be provided a connection portion which smoothly interconnects the first portion and the second portion. Thereby, it can be effectively prevented that the driver has bad feeling, which may be caused the considerably-large resistance acting on the heel of the pedal operational foot during a pedal changing period from the operation state of the acceleration pedal to the operation state of the brake pedal.

Other features, aspects, and advantages of the present invention will become apparent from the following description which refers to the accompanying drawings.

### BRIEF DESCRIPTION OF THE DRAWINGS

FIG. 1 is an explanatory diagram showing a first embodiment of a floor panel structure of a vehicle according to the present invention.

FIG. 2 is a back sectional view showing an arrangement structure of pedals.

FIG. 3 is a back-face sectional view taken along line of III-III of FIG. 2, which shows a specific structure of an acceleration pedal.

FIG. 4 is a sectional view taken along line IV-IV of FIG. 3.

FIG. 5 is an exploded perspective view showing a specific structure of the acceleration pedal.

FIG. 6 is a side sectional view showing an attachment structure of a floor mat.

FIG. 7 is a sectional view taken along line VII-VII of FIG. 2.

FIG. 8 is a side view showing specific structures of a longitudinal-position adjusting mechanism and a slant-angle adjusting mechanism of a seat.

FIG. 9 is a perspective view showing the specific structures of the longitudinal-position adjusting mechanism and the slant-angle adjusting mechanism of the seat.

FIG. 10 is a sectional view taken along line X-X of FIG. 8.

FIG. 11 is a side sectional view showing the specific structure of the slant-angle adjusting mechanism.

FIG. 12 is a plan sectional view showing the specific structure of the slant-angle adjusting mechanism.

FIG. 13 is a side view showing a state in which a seat cushion is moved forwardly in a vehicle.

FIG. 14 is a side view showing sitting states of an average-sized driver and a short driver.

FIG. 15 is an explanatory diagram showing placement states of heels of the average-sized driver and the short driver.

FIG. 16 is a side view showing sitting states of a tall driver and the average-sized driver.

FIG. 17 is an explanatory diagram showing a placement state of a heel of the tall driver.

FIG. 18 is a view showing a comparative example of the present invention, which corresponds to FIG. 7.

FIG. 19 is a view showing a modification of the first embodiment of the floor panel structure of a vehicle according to the present invention, which corresponds to FIG. 17.

FIG. 20 is an explanatory diagram showing a second embodiment of the floor panel structure of a vehicle according to the present invention.

FIG. 21 is a back sectional view showing the second embodiment, which corresponds to FIG. 2.

FIGS. 22A, B, C are graphs showing changing states of a load acting on the heel of the short driver.

FIGS. 23A, B, C are graphs showing changing states of a load acting on the heel of the average-sized driver.

FIGS. 24A, B, C are graphs showing changing states of a load acting on the heel of the tall driver.

FIG. 25 is a sectional view showing a third embodiment of the floor panel structure of a vehicle according to the present invention, which corresponds to FIG. 7.

### DETAILED DESCRIPTION OF THE INVENTION

Hereinafter, preferred embodiments of the present invention will be described referring to the accompanying drawings.

### Embodiment 1

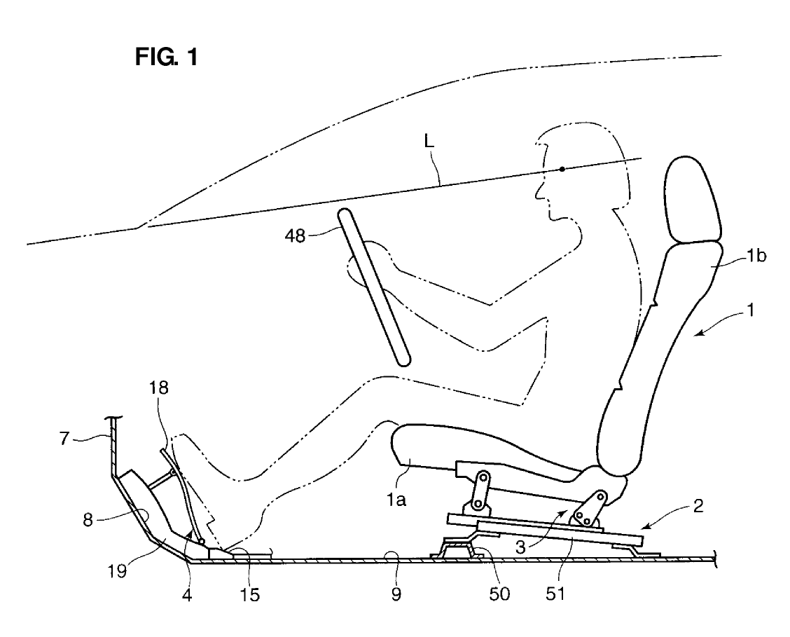

FIGS. 1 through 7 show a first embodiment of a floor panel structure of a vehicle according to the present invention. A driver's seat 1 is arranged on a floor panel 9 which forms a bottom face of a vehicle room, and there are also provided, in the vehicle room, a longitudinal-position adjusting mechanism 2 to adjust a longitudinal position of a seat cushion 1a by sliding it and a slant-angle adjusting mechanism 3 to adjust a slant angle of the seat cushion 1a. An acceleration pedal 4, a brake pedal 5, and a clutch pedal 6, which are operated by a driver seated in the driver's seat 1, are arranged at a front portion in the vehicle room.

A vehicle body of the vehicle comprises a dash panel 7 which partitions an engine room from the vehicle room, a kick-up panel 8 which extends obliquely downwardly and rearwardly from a lower end portion of the dash panel 7, and a substantially-flat floor panel 9 which extends from a rear end portion of the kick-up panel 8. On an upper surface of the floor panel 9 is placed a well-known floor carpet 12, which comprises a cushion material 10 which is mainly made of material having functions of vibration proof, sound insulation, heat insulation and so on, such as melt sheet, felt, or glass wool, and a layer material 11 which covers over an upper face of the material 10 and is made of pile material.

A heel pad material 13 is arranged in a heel placement area of the floor panel 9 where a heel of a right foot, as a pedal operational foot, of the driver is placed when the driver operates the operational pedal, i.e., the acceleration pedal 4 or the brake pedal 5. Further, a floor mat 14 is placed so as to cover over the heel pad material 13 and the floor carpet 12.

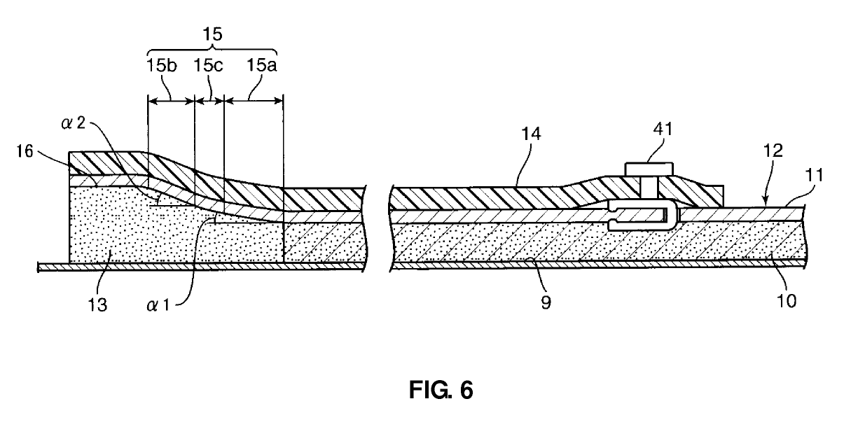

The heel pad material 13 is made of a material, such as urethane foam or synthetic rubber, which has a rigidity enough to support the heel of the pedal operational foot of the driver in a normal state and a resilience enough to absorb an impact energy acting on the heel of the pedal operational foot of the driver in the vehicle collision. The width, in a vehicle width direction, of the heel pad material 13 is set to a range from the heel placement area of the brake pedal 5 to the heel placement area of the acceleration pedal 4. The heel pad material 13 includes a slant floor portion 15 which slants in such a manner that its front portion is positioned at a higher level than its rear portion. The slant floor portion 15 is divided into a portion on the side of the driver's seat 15a and a portion on the side of the operational pedal 15b (see FIG. 6). Further, a horizontal face portion 16 which has a substantially-horizontal upper face is provided continuously at a front end portion of the slant floor portion 15.

A slant angle α1 of the portion on the side of the driver's seat 15a, i.e., a portion positioned rearwardly of the vehicle, of the slant floor portion 15 is set within a range of 5° to 15°, for example. Meanwhile, a slant angle α2 of the portion on the side of the operational pedal 15b, i.e., a portion positioned forwardly of the vehicle, of the slant floor portion 15 is set within a range of 15° to 25°, which is greater than the slant angle α1 of the portion on the side of the driver's seat 15a, for example. Further, between the portion on the side of the driver's seat 15a and the portion on the side of the operational pedal 15b is provided a middle area 15c where a slant angle increases gradually from an angle corresponding to the slant angle α1 of the portion on the side of the driver's seat 15a to another angle corresponding to the slant angle α2 of the portion on the side of the operational pedal 15b.

The heel pad material 13 is arranged in a space which is formed by cutting out a part of the back cushion material 10 of the floor carpet 12, and fixed on the upper surface of the floor panel 9 via adhesive or the like. The layer material 11 is placed so as to cover the upper face of the heel pad material 13, and the floor mat 14 is placed further on this material 11. Thus, the floor mat 14 has a slant face portion which corresponds to the slant floor portion 15 and a horizontal face portion which corresponds to the horizontal face portion 16 at its upper face.

An interference avoidance portion is provided in front of the slant floor portion 15. The interference avoidance portion has a slant degree which is smaller than a slant degree of the slant floor portion 15. That is, according to the first embodiment, the horizontal face portion 16 which has a substantially horizontal and flat face with its slant angle of about 0° is formed in front of the slant floor portion 15, thereby any interference of the driver's heel with the floor surface can be avoided during the pedal operation, which will be described below specifically.

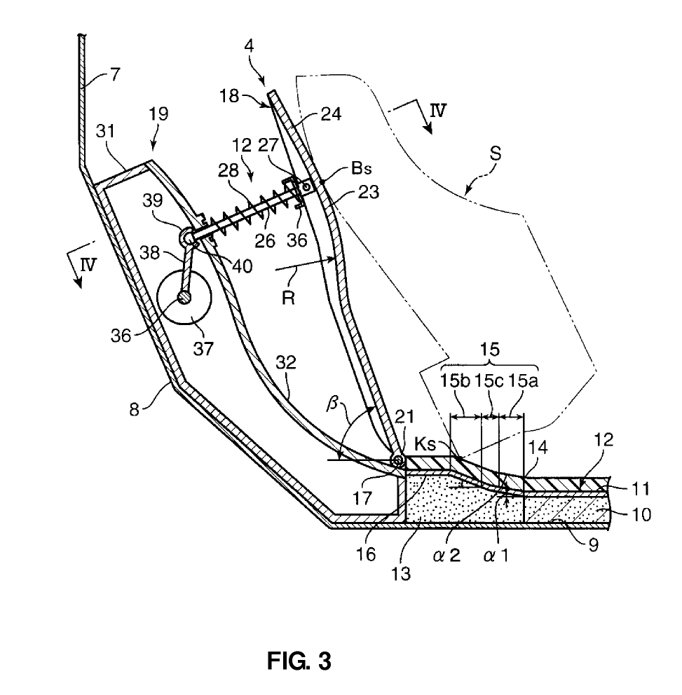

The acceleration pedal 4 is rotatably supported, as shown in FIGS. 3, 4 and 6, at its lower end portion around a pivotal support of a support axis 17 which is formed at a specified position of the floor panel 9 which corresponds to a foot portion of the driver seated in the driver's seat 1. This acceleration pedal 4 is comprised of a so-called organ type of operational pedal, which comprises a pedal body 18 which swings longitudinally in accordance with the driver's pressing operation, a pedal base portion 19 which supports the pedal body 18, and a pedal operation detecting portion 20 which detects a swinging displacement of the pedal body 18 and outputs its detection signal to a controller, not illustrated.

The pedal body 18 is made of a plate member which has an insertion portion 21, into which the above-descried support axis 17 is inserted, at its lower end portion. A pressing operational portion of the pedal body 18, which is positioned at its middle portion and contacted with a ball of the pedal operational foot with the heel placed on the floor mat 14 which is arranged in front of the driver's seat 1, includes a convex face portion 23 which projects toward the driver (rearwardly), in the side view, having the radius of curvature R1 of 100 mm to 200 mm.

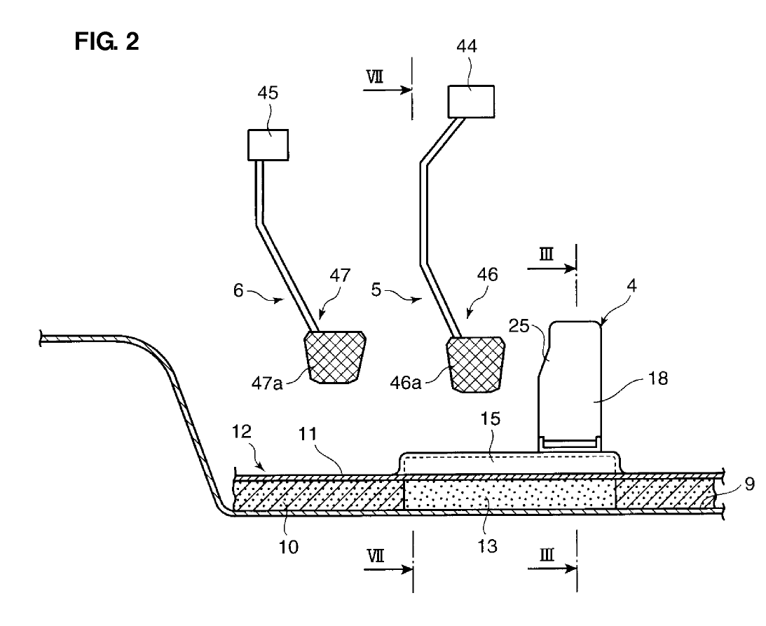

The pedal body 18 further includes a flat face portion 24 having the radius of curvature which is greater than that of the convex face portion 23 at its tip portion. In the first embodiment, the radius of curvature of the flat face portion 24 is set to be infinite, so that the flat face portion 24 extends straightly upwardly from an upper end portion of the convex face portion 23. Further, the pedal body 18 has an enlargement portion 25 having a wider width as shown in FIGS. 2, 6 and others. This enlargement portion 25 is formed so that a side portion of the convex face portion 23 which is positioned on the side of brake pedal 5 expands downwardly.

An operational rod 26 which constitutes the pedal operation detecting portion 20 is pivotally supported at the back face of the pedal body 18 via a connecting pin 27 or the like. The lower end portion of the pedal body 18 is supported at the support axis 17 of the pivotal support portion provided at the pedal base portion 19, and an upper portion of the pedal body 18 is supported at the pedal base portion 19 via a pedal support spring 28 which is arranged around the operational rod 26. Thereby, during the normal state (non-operational state), the pedal body 18 is held in a slant state with a slant angle β of 70° relative to the horizontal line, for example.

The pedal base portion 19 comprises a longitudinally-long box body 31 which has attachment portions 30 with bolt holes for stud bolts 29 fixed to the kick-up pane 8 and the floor panel 9 at its outer peripheral portion, and a lid body 32 which is attached so as to cover an upper opening of the box body 31. These stud bolts 29 are inserted into the attachment portions 30 of the box body 31 in a state in which a rear portion of the box body 31 contacts a front portion of the heel pad material 13, and fixing nuts (not illustrated) are fastened to the stud bolts 29, thereby fixing the pedal base portion 19 onto the floor panel 9.

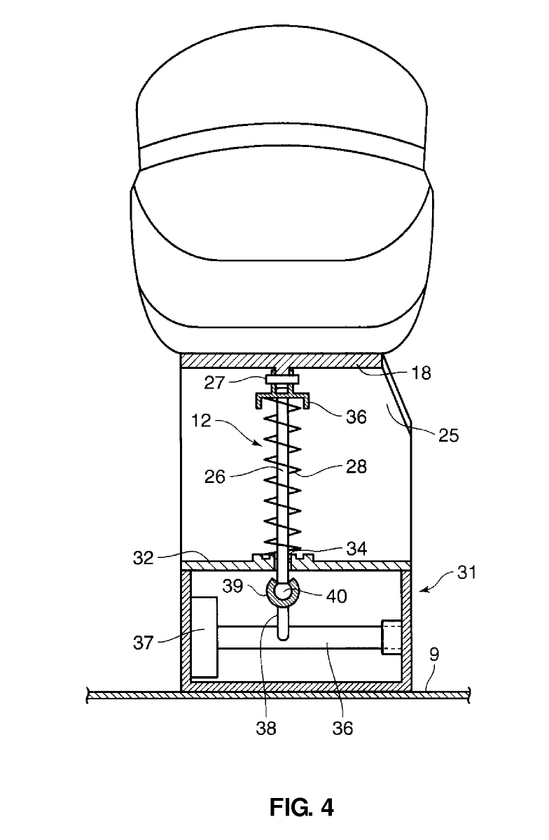

The lid body 32 of the pedal base portion 19 has screw holes 33 for screws (not illustrated) to be fastened at screw fixing portions formed at a peripheral wall portion of the box body 31 at its outer peripheral portion, and an insertion hole 34 for the above-described operational rod 26 at its central portion. A lower end portion of the pedal support spring 28 is supported at a peripheral edge portion of the insertion hole 34. Further, the lid body 32 has a pair of support portions 35 to support both-side end portions of the pivotal portion of the support axis 17 at its both-side lower end portions. Herein, in FIGS. 3 and 4, reference numeral 36 denotes a spring seat to support an upper end portion of the pedal support spring 28.

An encoder shaft 36 to be driven in accordance with a swing operation of the pedal body 18 is rotatably supported in the box body 31 of the pedal base portion 19, and an encoder 37 to detect a rotational position of the encoder shaft 36 is attached to a base end portion of the encoder shaft 36. Further, a drive arm 38 projects from a central portion of the encoder shaft 36, and a ball portion 40 which is formed at a base end of the operational rod 26 is rotatably coupled to a connection portion 39 which is formed at a tip of the drive arm 38 via a compressive insertion.

Further, a front portion of the floor mat 14 is placed on the horizontal face portion 16 formed at the front portion of the heel pad material 13, and the upper surface of the slant floor portion 15 and the floor carpet 12 which are located in back of the acceleration pedal 4 and the brake pedal 5 is covered with the floor mat 14. As shown in FIG. 6, a rear end portion of the floor mat 14 is fixed to the layer material 11 of the floor carpet 12 via a fixing tool 41 in a positioning state in which a front end face of the floor mat 14 contacts the rear end portion of the pedal base portion 19 as shown in FIG. 3. Herein, the front end portion and the side portion of the floor mat 14 may be fixed in the same manner at need.

In the above-described structure, when the driver places the heel of the pedal operational foot, i.e., the right foot, on the slant floor portion 15 covered with the floor mat 14 and the driver operates to press the pedal body 18 with the ball of the foot contacting the convex face portion 23 of the pedal body 18, the pedal body 18 is driven so as to swing forwardly around the pivotal portion of the support axis 17 against the biasing force of the pedal support spring 28. The drive force inputted to the pedal body 18 is transmitted to the encoder shaft 36 via the operational rod 26 and the drive arm 38. Thereby, the encoder shaft 36 is rotated, and the rotational amount is detected by the encoder 37. The detection signal is outputted to the controller, not illustrated, via the connector 42 and the harness 43.

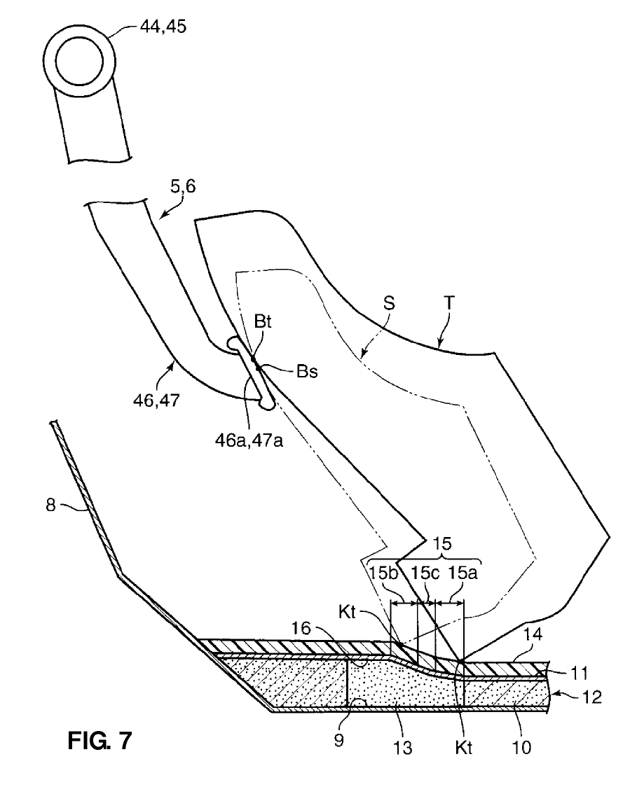

The brake pedal 5 arranged on the left side of the acceleration pedal 4 and the clutch pedal 6 arranged on the left side of the brake pedal 5 are, as shown in FIGS. 2 and 7, comprised of a so-called hanging type of pedal in such a manner that respective upper ends of their pedal bodies 46, 47 are pivotally supported at pivotal portions 44, 45 which are provided at the dash panel 7, and the pedal bodies 46, 47 swing around the pivotal portions 44, 45.

Herein, the driver operates to press the brake pedal 5 with the ball of the peal operational foot of the driver's right foot contacting a pressing operational portion 46a formed at a lower end portion of the pedal body 46. Thereby, the pedal body 46 swings around the upper-end pivotal portion 44. The driver operates to press the clutch pedal 6 with the ball of the peal operational foot of the driver's left foot contacting a pressing operational portion 47a formed at a lower end portion of the pedal body 47. Thereby, the pedal body 47 swings around the upper-end pivotal portion 45.

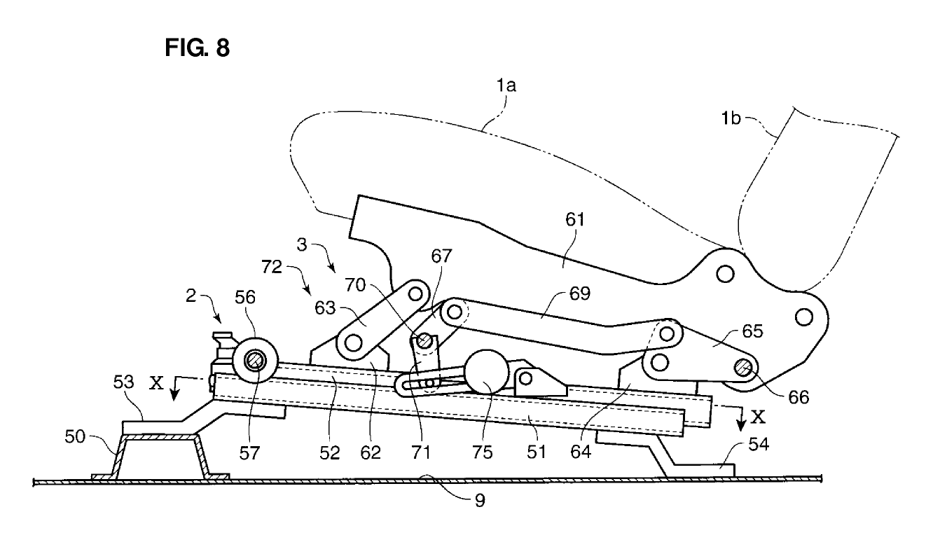

As shown in FIGS. 8 through 10, a pair of seat-slide lower rails 51 which supports the seat cushion 1a so that the seat cushion 1a can move longitudinally is provided at the disposition portion of the driver's seat 1, and a pair of seat-slide upper rails 52 is provided so as to slide along the seat-slide lower rails 51. The seat-slide lower rails 51 is made of a C-type steel member or the like which has an opening on the top thereof, and attaching brackets 53, 54 are fixed to their both longitudinal ends by welding or the like. These brackets 53, 54 are fixed to an upper face of a cross member 50 and the like by fastening bolts or the like, so that the seat-slide lower rails 51 is disposed on the vehicle floor 9 in a slant state in which the level of its front portion is slightly higher.

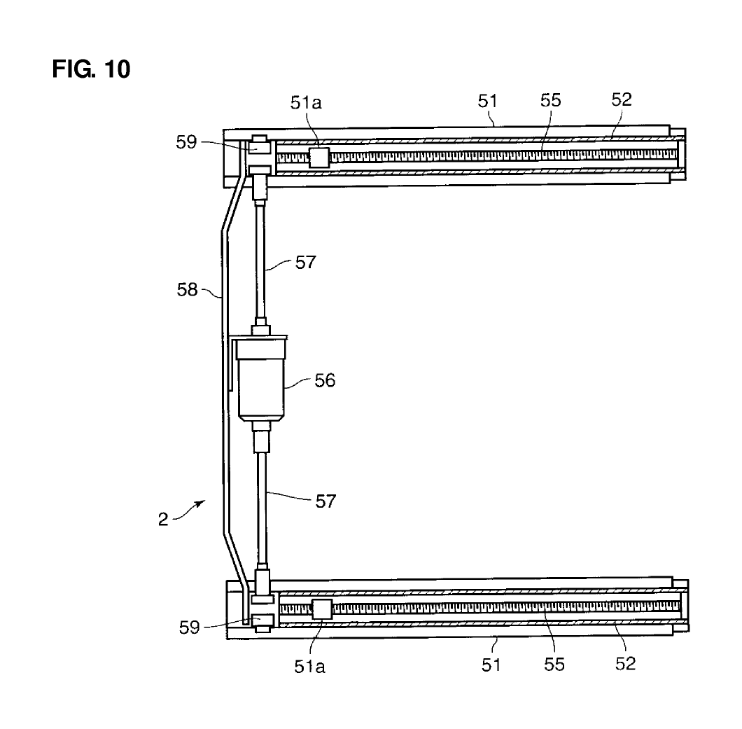

As shown in FIG. 10, a thread rotational shaft 55 is disposed inside each of the seat-slide lower rails 51, and a pair of drive shafts 57 which is rotated by a drive motor 56 and a support member 58 which supports the drive shafts 57 are provided respectively so as to extend in a vehicle width direction between both front ends of the seat-slide upper rails 52. At both-side end portions of the drive shafts 57 are provided drive-force transmitting portions 59 which transmit a drive force to the rotational shafts 55 via a mechanism which comprises bevel gears or worm gears.

The above-described seat-slide lower rails 51, seat-slide upper rails 52, rotational shaft 55, drive motor 56, drive shaft 57 and drive-force transmitting portion 59 constitute the longitudinal-position adjusting mechanism 2 together with a pair of nut blocks 51a which is fixed to respective bottom portions of the seat-slide lower rails 51 and engages with the respective rotational shafts 55. The longitudinal-position adjusting mechanism 2 adjusts the longitudinal position of the driver's seat 1 by making the seat cushion 1a of the driver's seat 1 slide along the seat-slide lower rails 51.

For example, when a longitudinal adjusting switch, not illustrated, is operated for a forward moving, a control signal to rotate the drive motor 56 in its normal direction is outputted and the diver motor 56 is rotated in the normal direction by this control signal. Thereby, the drive force for moving the seat cushion 1a forwardly is transmitted to the drive shafts 57, drive-force transmitting portions 59, and rotational shafts 55. The rotational shafts 55 are rotated by the drive force inputted via the drive-force transmitting portions 59 in a state in which these shafts 55 are supported at the nut blocks 51a which are fixed to the bottom portions of the seat-slide lower rails 51, so that the rotational shafts 55 proceed forwardly. Consequently, the seat-slide upper rails 52 and thereby the seat cushion 1a of the driver's seat 1 are moved forwardly.

Meanwhile, when the longitudinal adjusting switch is operated for a rearward moving, a control signal to rotate the drive motor 56 in its reverse direction is outputted and the diver motor 56 is rotated in the reverse direction by this control signal. Thereby, the drive force for moving the seat cushion 1a rearwardly is transmitted to the drive shafts 57, drive-force transmitting portions 59, and rotational shafts 55. The rotational shafts 55 are rotated by the drive force, so that the rotational shafts 55 proceed rearwardly. Consequently, the seat-slide upper rails 52 and thereby the seat cushion 1a of the driver's seat 1 are moved rearwardly.

Further, since the seat-slide lower rails 51 is disposed on the vehicle floor 9 in the slant state in which the level of its front portion is slightly higher, the seat cushion 1a is pushed upwardly as the seat-slide upper rails 52 and the seat cushion 1a of the driver's seat 1 move forwardly along the seat-slide lower rails 51. On the contrary, the seat cushion 1a is lowered as the seat-slide upper rails 52 and the seat cushion 1a of the driver's seat 1 move rearwardly along the seat-slide lower rails 51.

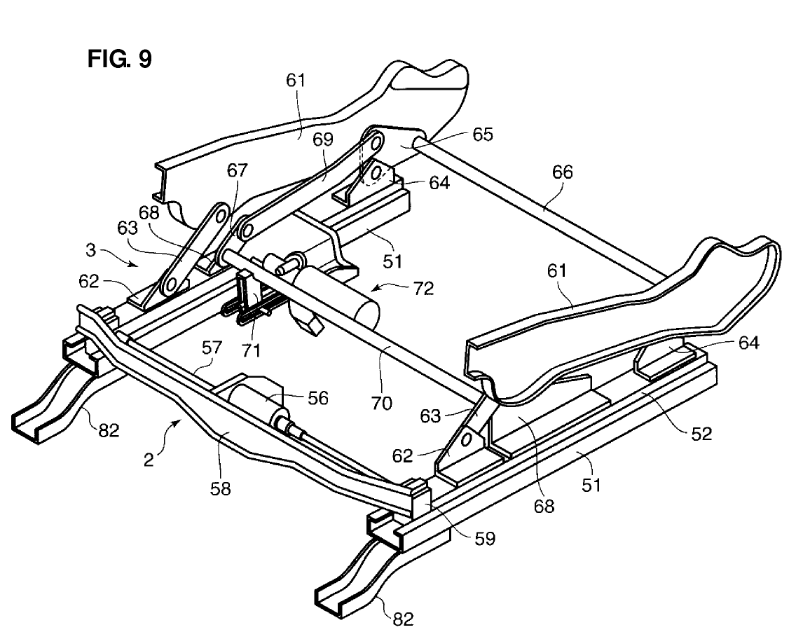

Moreover, at each of the seat-slide upper rails 52 is provided the slant-angle adjusting mechanism 3 which adjusts the slant angle of the seat cushion 1a of the driver's seat 1. The slant-angle adjusting mechanism 3, as shown in FIGS. 8 and 9, comprises a cushion frame 61 which is provided at a side portion of the seat cushion 1a, a front bracket 62 and a front link 63 which are provided on a front upper face of the seat-slide upper rail 52 and supports a front end of the cushion frame 61, a rear bracket 64 and a triangular-shaped rear link 65 which are provided on a rear upper face of the seat-slide upper rail 52 and supports a rear portion of the cushion frame 61, a connecting shaft 66 which interconnects rear end portions of the both-side rear links 65 and rear end portions of the both-side cushion frames 61, a center link 67 which transmits a drive force to the rear link 65 and a center bracket 68 which is provided on a central upper face of the seat-slide upper rail 52 and supports this center link 67, a connecting link 69 which connects an upper portion of the central link 67 to a front end of the rear link 65, a drive shaft 70 which will be specifically described below, and a drive lever 71 and a slant drive portion 72.

The central link 67 is fixed to the drive shaft 70 which extends in the vehicle width direction at its end portion, and this link 67 is rotatably supported at the central bracket 68 via the drive shaft 70. The drive lever 71 which rotates the drive shaft 70 is fixed to the drive shaft 70. Herein, the above-described slant drive portion 72 which drives this drive lever 71 is provided at the central bracket 68 which is fixed to either one of the seat-slide upper rails 52 (one on the outward side).

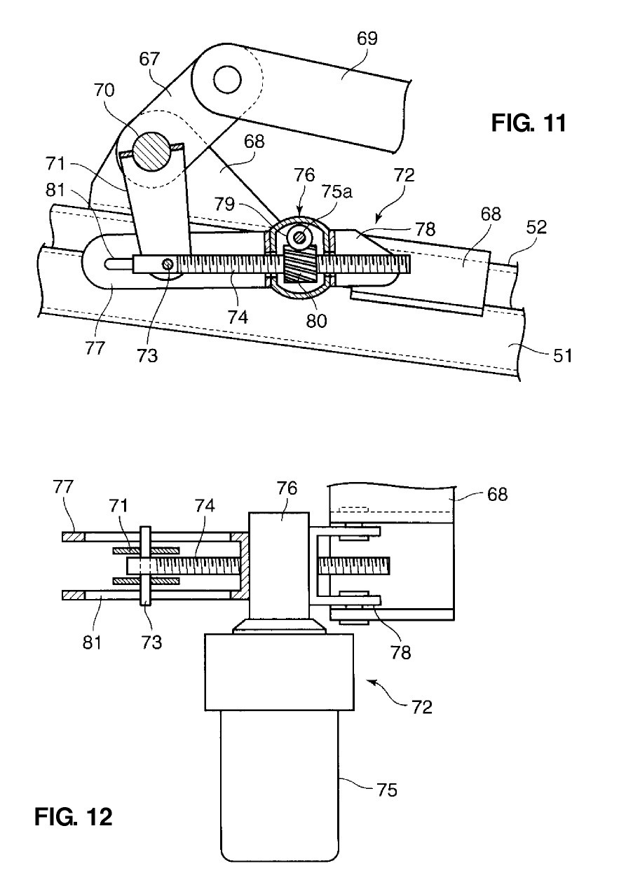

The slant drive portion 72 comprises, as shown in FIGS. 11 and 12, a screw shaft 74 which is connected to a tip (lower end) of the drive lever 71 via a connecting pin 73 at its front end, a drive motor 75 to rotate the screw shaft 74 and a gear mechanism 76, and a guide bracket 77 which is fixed to a front face of the gear mechanism 76 and a base end of which is supported at the central bracket 68 via a support bracket 78. Further, the gear mechanism 76 comprises a worm gear 79 which is fixed to an output shaft 75a of the drive motor 75 and a worm nut 80 which is rotated by the worm gear 79. The worm nut 80 has a screw hole formed thereat which the screw shaft 74 engages with.

Herein, as the worm nut 80 is rotated by the drive force which is inputted from the drive motor 75 via the worm gear 79, the screw shaft 74 is rotated. Thereby, the connecting pin 73 at the tip of the screw shaft 74 moves longitudinally along a support groove 81 which is formed at the guide bracket 77, and the drive force is transmitted to the drive lever 71 via the connecting pin 73. Accordingly, the drive lever 71 swings and thereby the drive shaft 70 is rotated.

Further, the central link 67 swings according to the rotation of the drive shaft 70, and the rotational drive force is transmitted to the rear link 65 via the connecting link 69. As the rear link 65 swings, the front link 63 also swings. Consequently, the slant angle of the seat cushion 1a can be adjusted. That is, when the seat cushion 1a of the driver's seat 1 moves to its rear position, as shown in FIG. 8, the front link 63 and the central link 67 take a their rearward slant positions and the connecting shaft 66 which is provided at the rear end of the rear link 65 takes its lower position. Consequently, a sitting face of the seat cushion 1a is held in its slant state in which it rear portion lowers greatly.

According to the above-described structure, when the forward moving operation of the driver's seat 1 with the longitudinal adjusting switch is conducted, the control signal for rotating the drive motor 75 of the slant-angle adjusting mechanism 3 in the normal direction is outputted from the controller, not illustrated, based on preset drive characteristics. The driving force of the normal-direction rotation of the drive motor 75 is transmitted to the central link 67 via the gear mechanism 76, screw shaft 74, connecting pin 73, drive lever 71 and drive shaft 70, and thereby the central link 67 changes its position from the rearward slant state to its standing state which is shown in FIG. 12. According to this position change of the central link 67 to the standing state, the drive force is transmitted to the rear link 65 via the connecting link 69, and the front end of the rear link 65 is pulled forwardly. Accordingly, the connecting shaft 66 which is provided at the rear end of the rear link 65 rises up, so that the rear end potion of the seat cushion 1a is pushed upwardly.

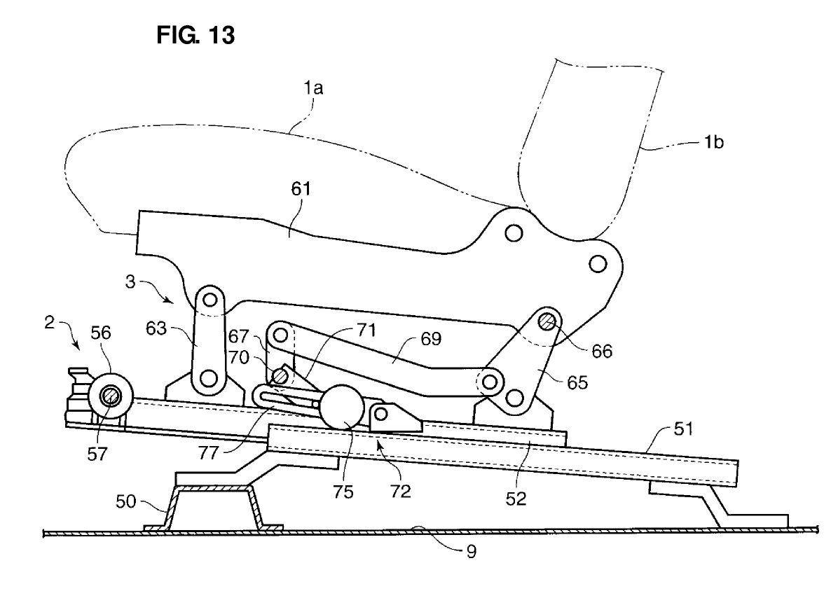

Further, since the front link 63 moves from its rearward slant state to its standing state according to the swing move of the rear link 65, the seat cushion 1a moves in such a manner that its front end portion rises and moves forwardly, so that the seat cushion 1a moves from the lower position to the upper position shown in FIG. 13. Herein, since the upper move quantity of the rear end portion of the seat cushion 1a is set to be greater than that of the front end portion of the seat cushion 1a, the seat cushion 1a moves so as to approach a horizontal state gradually. Depending on this move of the seat cushion 1a, the seat back 1b moves so as to approach its upright position.

Meanwhile, when the rearward moving operation of the driver's seat 1 with the longitudinal adjusting switch is conducted, the control signal for rotating the drive motor 75 of the slant-angle adjusting mechanism 3 in the reverse direction is outputted from the controller, not illustrated, based on preset drive characteristics. The driving force of the reverse-direction rotation of the drive motor 75 is transmitted to the central link 67 via the gear mechanism 76, screw shaft 74, connecting pin 73, drive lever 71 and drive shaft 70. Accordingly, as shown in FIG. 8, the seat cushion 1a changes from the upper position to the lower position. Herein, the drive characteristics are set in such a manner that the rearward slant angle of the sitting face of the seat cushion 1a increases and the seat back 1b slants rearward greatly depending on the lowering of the seat cushion 1a.

Herein, if the driver seated in the driver's seat 1 changes to a different driver having a different height, the eye point of the driver seated, operational functions for the operational pedals and the like may change because the driver's sitting height, the length of the driver's arm, the length of the driver's leg and the like change as well. Therefore, the new driver may try to operate the longitudinal-position adjusting mechanism 2 and the slant-angle adjusting mechanism 3 to adjust the driver's position so that the driver can hold a steering wheel 48 in the properly comfortable position, make the ball of the driver's foot properly contact an appropriate position, such as the convex face portion 23 of the pedal body 18, of the acceleration pedal 4, and the clear front view of the driver can be ensured by matching the driver's eye point to an appropriate line L.

The drivers with the height within the range of 150 to 190 cm may be seated in the driver's seat 1, so it is necessary that any driver can be seated in the seat 1 having the comfortable sitting position and conduct the driving operation properly. Herein, the statistical analysis on the appropriate position for the average-sized driver M with the height of 174 cm was conducted, and the results below were obtained.

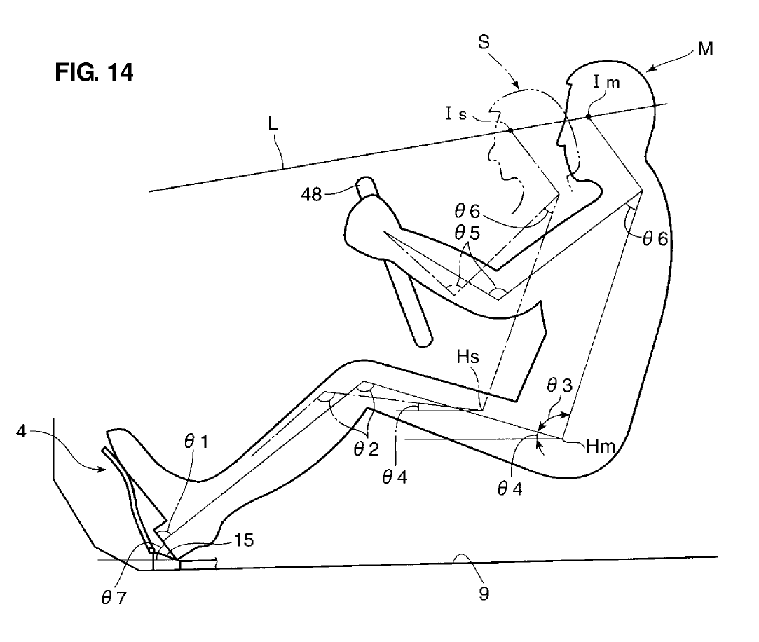

Herein, the comfortable position of the driver seated in the driver's seat 1 means a sitting position which can make the driver keep the sitting state for a long period of time and also suit for operating the steering wheel, pedals and so on. Specifically, as shown in FIG. 14, the angle of ankle θ1 is about 85 to 95 degrees, the angle of knee θ2 is about 115 to 135 degrees, and the bending angle θ3 between the upper half body and the thigh portion is about 95 degrees. Further, it has been verified from the human-technology tests that the appropriate angle of the thigh angle θ4 relative the horizontal line for the average-sized driver M is an angle which is obtained by adding about 1.5 degrees to the slant angle of the seat cushion 1a. Further, the elbow angle θ5 which can provide the proper operation of steering wheel 48 is about 100 to 130 degrees, and the armpit portion angle θ6 is about 20 to 45 degrees.

Accordingly, the longitudinal standard position and the vertical standard position of the seat cushion 1a are set so that when the above-described average-sized driver M is seated in the driver's seat in a state, for example, in which the ankle angle θ1 is 90 degrees, the knee angle θ2 is 125 degrees, the bending angle θ3 between the upper half body and the thigh portion is degrees, and the thigh angle θ4 is 17 degrees, the eye point Im of the average-sized driver M can be made match the appropriate line L which has the inclination angle of 8 degrees.

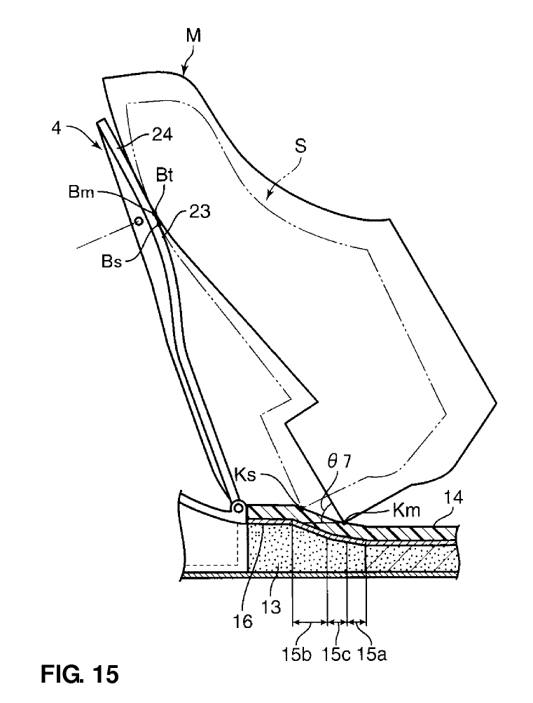

According to the above-described standard sitting state of the average-sized driver M, the elbow angle θ5 and the armpit portion angle θ6 are set within the above-described respective ranges so that the driver can hold the steering wheel 48 properly. Further, as shown in FIG. 15, the acceleration pedal 4 is disposed at an appropriate position so that the ball of the foot Bm of the driver's foot contacts an upper portion of the convex face portion 23 near the above-described flat face portion 24 formed at the pedal body 18 in a state in which a heel Km of the driver's foot is placed at a specified position on the above-described slant floor portion 15 and the inclination angle θ7 of the sole relative to the horizontal line is about 59.5 degrees.

In FIG. 14, reference character Hm denotes the hip point (sitting standard point) of the average-sized driver M seated in the driver's seat 1. Further, in the present embodiment, as shown by a solid line in FIG. 15, the standard disposition position of the heel Km of the average-sized driver M is set to a specified position in the middle area 15c formed at the slant floor portion 15, or to a front position of the portion on the side of the driver's seat 15a, for example.

Meanwhile, when the driver seated in the driver' seat 1 changes from the average-sized driver M to the short driver S, such as an woman deriver, as shown by a broken line in FIG. 14, this short driver S may operate the longitudinal-position adjusting mechanism 2 and the slant-angle adjusting mechanism 3 to move the seat cushion 1a forwardly so that the operational functions of the steering wheel and the pedal can be ensured and the eye point Is can be matched to the appropriate line L. Further, the driver S may operate to raise the disposition level of the seat cushion 1a and reduce the slant angle of the seat cushion 1a relative to the horizontal line accordingly.

For example, when the short driver S with the height of 150 cm is seated in the driver's seat 1, the short driver S operates so as to move the hip point Hs on the seat cushion 1a forwardly about 105 mm from the longitudinal standard position Hm of the average-sized driver M and upwardly about 25 mm, and to change the slant angle of the seat cushion 1a so that the thigh angle θ4 can be about 10.5 degrees. As a result, the upper half body of the short driver S who has a shorter arm than the average-sized driver M is moved forwardly so that the steering wheel 48 can be held in the appropriate position, and the eye point Is of the short driver S who has a shorter sitting height than the average-sized driver M is moved upwardly and forwardly so that the eye point Is can match the appropriate line L.

Moreover, there is a tendency that the pedal-operating foot of the short driver S moves upwardly and forwardly according to the upward and forward move of the seat cushion 1a. Therefore, by increasing the knee angle θ2 to about 130 degrees accordingly, the ball of the foot Bs of the short driver S can be made contact the appropriate position of the upper portion of the convex face portion 23 near the flat face portion 24 formed at the pedal body 18 of the acceleration pedal 4, keeping the ankle angle θ1 at about 90 degrees.

Since the distance (about 160 mm) from the heel Ks of the short driver S to the ball of the foot Bs is about 30 mm shorter than that (about 190 mm) of the average-sized driver M, in order that the ball of the foot Bs is made contact the above-described appropriate position of the acceleration pedal 4, keeping the sole's inclination angle θ7 of the short driver S at the angle which is the same as that (59.5 degrees) of the average-sized driver, the heel Ks is located at a level which is about 26 mm (=sin 59.5 degrees×30 mm) higher than the heel Km of the average-sized driver M. Therefore, unless the heel Ks of the short driver S is located above off the floor panel 9, the ball of the foot Bs of the short driver S may not be made contact the appropriate position, i.e., the upper portion of the convex face portion 23 securely. Meanwhile, in case the heel Ks of the short driver S is located above off the vehicle floor 8, it may be difficult to operate the pedal precisely with the pivotal move around the heel Ks.

However, in case the slant angle α2 of the portion on the side of the operational pedal 15b of the slant floor portion 15 which is located in front of the middle area 15c is set to 20 degrees, for example, by changing the sole's inclination angle θ7 of the short driver S from 59.5 degrees to about 67 degrees and moving the heel Ks about 27 mm forwardly from the standard position on the slant floor portion 15 (the disposition position of the heel Km of the average-sized driver M), as shown in a phantom line in FIG. 15, the ball of the foot Bs can be made contact the appropriate position of the upper portion of the convex face portion 23 formed at the acceleration pedal 4 in a state in which the heel Ks is placed at the specified position on the portion on the side of the operational pedal 15b of the slant floor portion 15 which is located about 10 mm above the horizontal flat portion.

Herein, there is a tendency that the ankle angle θ1 of the foot becomes smaller than 90 degrees as the sole's inclination angle θ7 changes from 59.5 degrees to 67 degrees. However, by increasing the knee angle θ2 of the short driver S to a specified angle greater than 130 degrees so that the knee can extend further according to the increase of the sole's inclination angle θ7 (see the broken line in FIG. 14), it can be prevented that the ankle angle θ1 becomes smaller beyond the appropriate range, for example, smaller than 85 degrees.

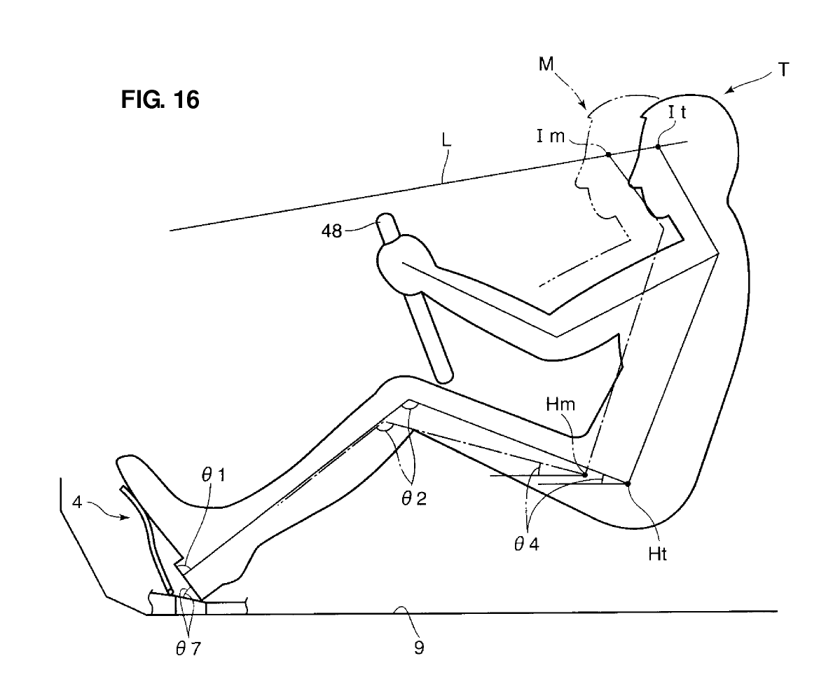

Meanwhile, when the tall driver T with the height of 189 cm is seated in the driver's seat 1, for example, as shown in FIG. 16, the tall driver T operates so as to move the hip point Ht on the seat cushion 1a rearwardly about 85 mm from the longitudinal standard position Hm of the average-sized driver M and downwardly about 20 mm, and to change the slant angle of the seat cushion 1a so that the thigh angle θ4 can become about 20.0 degrees. As a result, the upper half body of the tall driver T who has a longer arm than the average-sized driver M is moved rearwardly so that the steering wheel 48 can be held in the appropriate position, and the eye point It of the tall driver T who has a longer sitting height than the average-sized driver M is moved downwardly and rearwardly so that the eye point It can match the appropriate line L.

Moreover, there is a tendency that the pedal-operating foot of the tall driver T moves downwardly and rearwardly in accordance with the downward and rearward move of the seat cushion 1a. Therefore, by decreasing the knee angle θ2 to about 120 degrees accordingly, the ball of the foot Bt of the tall driver T can be made contact the appropriate position of the upper portion of the convex face portion 23 of the acceleration pedal 4, keeping the ankle angle θ1 at about 90 degrees.

Since the distance (about 206 mm) from the heel Kt of the tall driver T to the ball of the foot Bt is about 16 mm longer than that (about 190 mm) of the average-sized driver M, in case the heel Kt is disposed at the same position, keeping the sole's inclination angle θ7 of the tall driver T at the same angle (59.5 degrees), it may be necessary that the contact position of the ball of the foot Bt to the convex face portion 23 of the acceleration pedal 4 is lowered by about 14 mm (=sin 59.5 degrees×16 mm) from that of the average-sized driver M.

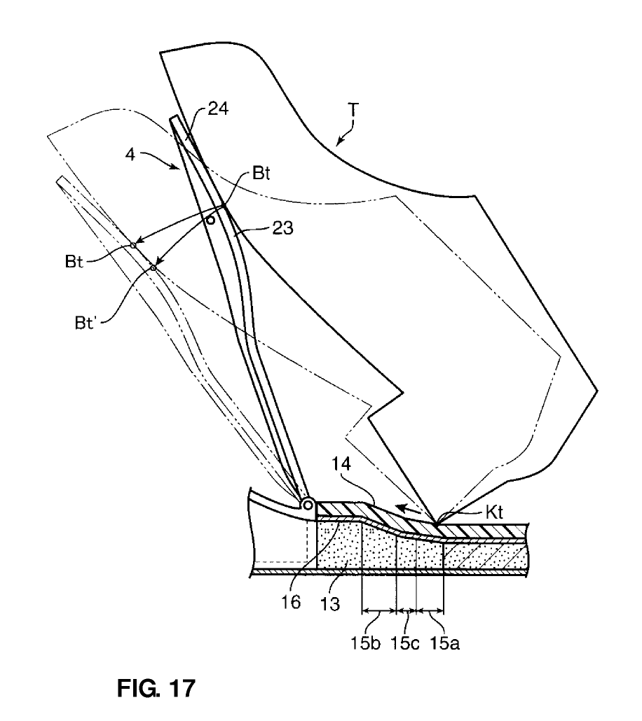

In the above-described first embodiment, by changing the sole's inclination angle θ7 of the tall driver T from 59.5 degrees to about 57 degrees and moving the heel Kt onto the portion on the side of the driver's seat 15a of the slant floor portion 15, or the horizontal face portion of the placement portion of the floor carpet 12 which is positioned rearwardly, as shown in FIG. 17, the rear the ball of the foot Bt can be made contact the appropriate position of the acceleration pedal 4. Herein, there is a tendency that the ankle angle θ1 of the foot becomes greater than 90 degrees as the sole's inclination angle θ7 changes from 59.5 degrees to 57 degrees. However, by decreasing the knee angle θ2 of the tall driver T to a specified angle smaller than 120 degrees so that the knee can bend according to the decrease of the sole's inclination angle θ7 (see FIG. 16), it can be prevented that the ankle angle θ1 becomes greater beyond the appropriate range, for example, greater than 95 degrees.

As described above, in the vehicle in which the driver's seat 1 is provided on the floor panel 9 forming the bottom portion of the vehicle room and the operational pedal, such as the acceleration pedal 4 and the brake pedal 5, is provided in front of the driver's seat 1, the slant floor portion 15 is provided in the heel placement area of the floor panel 9 on which the heel of the pedal operational foot of the driver pressing the operational pedal is placed, the slant floor portion 15 slanting with the specified slant degree in such a manner that its front portion is positioned at the higher level than its rear portion, and the interference avoidance portion is provided in front of the slant floor portion 15, the interference avoidance portion having the slant degree which is smaller than the specified slant degree of the slant floor portion 15 so as to avoid interference with the heel of the driver's foot. Accordingly, the pedal operation can be improved effectively with the simple structure.

That is, since the above-described slant floor portion 15 is formed in the heel placement area of the floor panel 9 positioned in back of the acceleration pedal 4 and the brake pedal 5 in the first embodiment, as shown by the phantom lines in FIGS. 15 and 7, even the short driver S having a shorter sole's length than the average-sized driver M can make the ball of the ball of the foot Bs contact the appropriate position of the upper portion of the convex face portion 23 near the flat face portion 24 of the acceleration pedal 4 or the pressing operational portion 46a of the brake pedal 5, keeping the ankle's angle θ1 and the sole's inclination angle θ7 of the short driver S at the appropriate angles, in a state in which the heel Ks of the pedal operational foot is placed on the front portion of the first slant floor portion 15.

Accordingly, it can be prevented that the delicate pedal operation becomes impossible, which may be caused by a situation where the heel Ks of the pedal operational foot of the short driver S is away from the floor surface. Further, it can be prevented that the prompt pressing operation of the operational pedal becomes difficult, which may be caused by a situation where the ankle's angle θ1 and the sole's inclination angle θ7 are away from the respective appropriate angles. The ball of the foot Bs can be made contact the appropriate position having the heel Ks of the short driver S placed on the slant floor portion 15, so that the delicate pedal operation of the acceleration pedal 4 and the brake pedal 5 can be properly achieved.

In case of the tall driver T, as shown in FIG. 16, for example, the ball of the foot Bt of the pedal operational foot can be made contact the appropriate position of the acceleration pedal 4 and the other easily and properly by decreasing the sole's inclination angle θ7 and making the knee angle θ2 smaller, without lowering the heel Kt very much. Accordingly, the tall driver T, as shown in FIG. 17 and others, can properly conduct the delicate pressing operation of the operational pedal in a sate in which the heel Kt is placed on the rear portion of the slant floor portion 15 or the horizontal face portion positioned rearwardly and the ball Bt contacts the appropriate position of the operational pedal.

Further, since the interference avoidance portion which is comprised of the horizontal face portion 16 in the present embodiment is provided at the front portion of the slant floor portion 15, it can be properly prevented with a simple structure that the driver has the bad feelings which may be caused by the improper pressing of the driver's heel against the upper surface of the slant floor portion 15, for example, when a gentle braking state in which the brake pedal 5 is pressed so as to delicately adjust the pressing amount is changed to a quick braking state in which the pressing amount of the brake pedal 5 is increased promptly in a state in which the driver places the heel of the pedal operational foot on the slant floor portion 15. Thereby, the proper pedal operation can be secured.

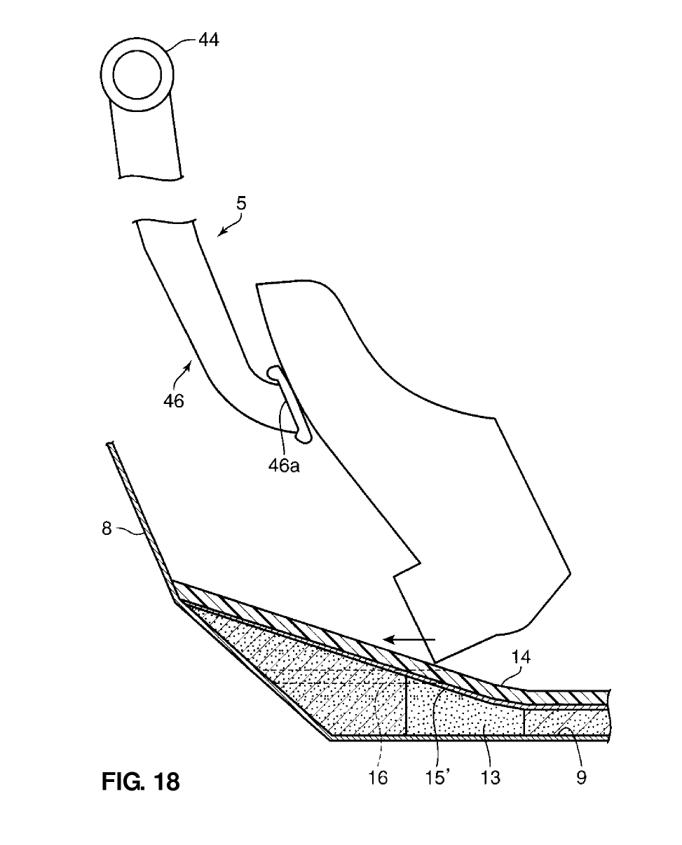

For example, in case a slant floor portion 15′ is formed over an entire range from the heel placement area on the floor panel 9 where the heel of the pedal operational foot is placed in pressing the brake pedal 5 to the front portion in front of the above-described heel placement area as shown by the solid line in FIG. 18, there is a problem in that when the driver conducts the quick braking operation of the brake pedal 5 in a state in which the heel of the driver's pedal operational foot is away from the upper surface of the slant floor portion 15′ and at the timing the pressing amount of the brake pedal 5 increases a specified value or greater, a considerably-large resistance acts on the heel of the pedal operational foot contacting the upper surface of the slant floor portion 15′ so that the driver would have bad feelings and thereby the smooth pedal operation would become difficult.

However, in case the interference avoidance portion comprised of the horizontal face portion 16 which has the substantially-flat upper face is provided at the front portion of the slant floor portion 15 as shown in the first embodiment, it is possible to conduct the above-described quick braking operation properly, keeping the state in which the heel Kt of the tall driver is away from the horizontal face portion 16 (see illustration by the broken line in FIG. 18), for example. Further, even in case of driver's promptly changing the pedal operation from the pressing operation of the acceleration pedal 4 to the pressing operation of the brake pedal 5, it can be prevented that the driver's heel is pressed against the upper surface of the slant floor portion 15, so that the brake pedal 5 can be properly operated.

Further, in the above-described first embodiment, as shown in FIGS. 3, 7 and others, the slant floor portion 15 is provided in the heel placement area of the floor panel 9 on which the heel of the right pedal-operational foot of the driver pressing the acceleration pedal 4 and the brake pedal 5 as the operational pedal are placed, and also the slant angle α2 of the portion on the side of the operational pedal 15b of the slant floor portion 15 is set to be greater (steeper) than the slant angle α1 of the portion on the side of the driver's seat 15a. Thereby, the pedal operation can be conducted more properly and with a simple structure even the sole's length changes depending on the body size of the driver seated in the driver's seat 1.

That is, since in the first embodiment the slant angle α1 of the portion on the side of the driver's seat 15a of the slant floor portion 15 is set within the range of 5° to 15°, and the slant angle α2 of the portion on the side of the operational pedal 15b is set within the range of 15° to 25°, even the short driver S having the shorter sole's length than the average-sized driver M can make the ball of the ball of the foot Bs contact the appropriate position of the upper portion of the convex face portion 23 near the flat face portion 24 of the acceleration pedal 4 or the like, keeping the ankle's angle θ1 and the sole's inclination angle θ7 at the appropriate angles, in a state in which the heel Ks of the pedal operational foot is placed on the portion on the side of the operational pedal 15b of the slant floor portion 15. Thereby, the pressing operation of the acceleration pedal 4 and the other can be conducted easily and properly.

Meanwhile, in case of the tall driver T, as shown in FIGS. 16 and 17, the ball of the foot Bt of the pedal operational foot can be made contact the appropriate position of the acceleration pedal 4 and the other easily and properly by decreasing the sole's inclination angle θ7 and making the knee angle θ2 smaller, without lowering the heel Kt very much. Accordingly, even in case the slant angle α1 of the portion on the side of the driver's seat 15a of the slant floor portion 15 is set to be smaller than the slant angle α2 of the portion on the side of the operational pedal 15b, and the placement area of the heel Kt of the pedal operational foot of the tall driver T is set to be positioned on the portion on the side of the driver's seat 15a or the horizontal face portion positioned rearwardly, the pressing operation of the acceleration pedal 4 and the other may not be deteriorated.

Herein, if the slant angle α2 of the portion on the side of the operational pedal 15b of the slant floor portion 15 is set to be too steep (great), the heel placed on the portion on the side of the operational pedal 15b may slip easily during the pedal operation. If this slant angle α2 is set to be too gentle (small), the short driver S may not prevent effectively a state in which the heel Ks of the pedal operational foot is away from the floor surface. Thus, it is preferable that the slant angle α2 be set within the range of 15° to 25°.

In case the placement portion of the heel Kt of the pedal operational foot of the tall driver T is set on the portion on the side of the driver's seat 15a of the slant floor portion 15, since the heel Kt is placed at the position which is away from the support axis 17 of the pivotal support of the pedal body 18 of the acceleration pedal 4, there is a tendency that the ball Bt shifts toward a lower position Bt′ from the appropriate position of the upper portion of the convex face portion 23 as the amount of pressing operation of the acceleration pedal 4 becomes greater, as shown by a phantom line in FIG. 17.

Herein, the tall driver T may try to move the heel Kt forwardly to keep the ball Bt of the driver's foot on the appropriate position. If the slant angle α1 of the portion on the side of the driver's seat 15a of the slant floor portion 15 where the heel Kt is placed is great, the heel Kt of the driver may be pressed against the upper face of the portion on the side of the driver's seat 15a and thereby a large slide resistance may act, so that there is a concern that the driver may have bad feelings. However, in case the slant angle α1 of the portion on the side of the driver's seat 15a of the slant floor portion 15 is set within the range of 5° to 15° so that the upper face of the portion on the side of the driver's seat 15a is gentler than that of the portion on the side of the operational pedal 15b as described above, it can be effectively prevented that the driver has bad feelings which may be caused by the large resistance acting on the heel Kt.

Further, if the slant angle α1 of the portion on the side of the driver's seat 15a of the slant floor portion 15 is too steep (great), the effect of decreasing the slide resistance when the heel Kt of the tall driver T moves forwardly during the pedal operation may not be obtained sufficiently. If this slant angle α1 is too gentle (small), the heel Km may be away from the floor surface when the average-sized driver M having a shorter sole length than the tall driver T conducts the pedal operation, so that the delicate pedal operation may be hindered. Thus, it is preferable that the slant angle α1 be set within the range of 5° to 15°.

Moreover, since the middle area 15c having the slant angle which gradually increase from the portion on the side of the driver's seat 15a of the slant floor portion 15 to the portion on the side of the operational pedal 15b is provided in the first embodiment, adjusting the placement height of the heel Km in case the average-sized driver M moves the heel Km longitudinally on the middle area 15c so as to position the heel Km at the appropriate placement height can be conducted without having bad feelings. That is, if the above-described portions 15a, 15b are directly connected without the middle area 15c, the slant angle of the upper face at this connection portion may change considerably. Accordingly, when the average-sized driver M adjusts the placement height of the heel Km through the longitudinal move of the heel Km on the slant floor portion 15, the smooth moving of the heel Km may be hindered at this connection portion, so that the driver may feel bad feelings. However, providing the above-described middle area 15a can prevent the driver from having bad feelings effectively.

Also, in case the above-described convex face portion 23 with the curve face having the radius of curvature of 100-200 mm, for example, is formed at the acceleration pedal as shown in the first embodiment, the contact point of the sole of the driver's foot with the acceleration pedal 4 can be made change smoothly and continuously on the convex face portion 23. Accordingly, even if the ball of the pedal operational foot shifts in a vertical direction of the convex face portion 23 in accordance with the pressing operation of the acceleration pedal 4, which may be caused by a situation where the heel of the pedal operational foot is away from the support axis 17 at the lower end portion of the pedal body 18 of the acceleration pedal 4, the driver can be effectively prevented from having bad feelings.

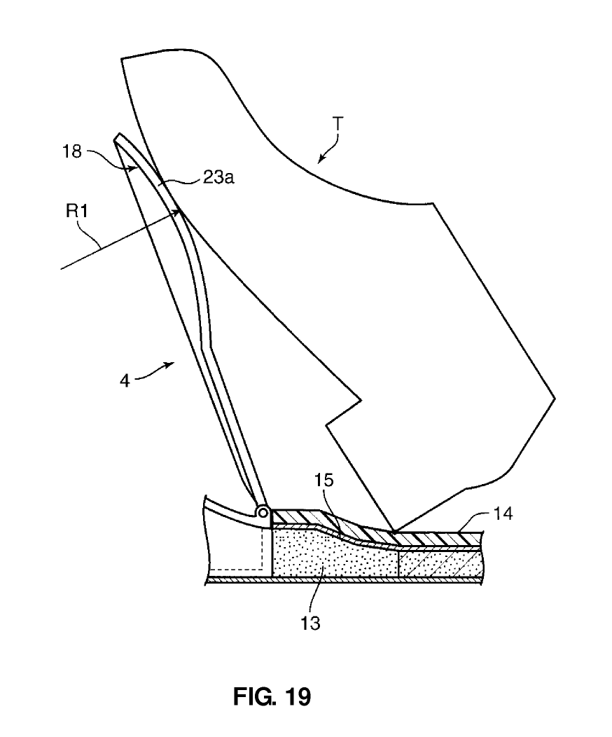

Herein, in place of the first embodiment in which the flat face portion having the larger radius of curvature than the convex face portion, for example, the flat face portion 24 which has the infinite radius of curvature so as to extend straightly is continuous from the upper end portion of the convex face portion 23, the entire of the upper portion of the pedal body 18 of the acceleration pedal 4 may be comprised of a convex face portion 23a with a curve face having the radius of curvature R1 as shown in a modification of FIG. 19. However, according to this modification, in case the tall driver T who has the long sole's length and a toe portion being positioned away above the pedal body 18 presses the acceleration pedal 4 with the pedal operational foot, the toe portion and a lower portion of the pedal operational foot of the tall driver T are positioned greatly away from the upper portion of the pedal body 18. Thus, it may be impossible to conduct the pressing operation through a face contact of the sole of the pedal operational foot with the pedal body 18, and therefore the driver may have uneasy feelings during the pedal operation.

Meanwhile, in case the flat face portion having the greater radius of curvature than the convex face portion 23 is provided at the upper end portion of the convex face portion 23 like the above-described first embodiment, the tall driver T can conduct the pedal pressing operation in a state in which the sole of the tall driver T contacts both of the convex face portion 23 and the flat face portion 24 of the pedal body 18 through the face contact as shown in FIG. 17. Accordingly, the driver can conduct the pressing operation of the acceleration pedal 4 with a feeling of security.

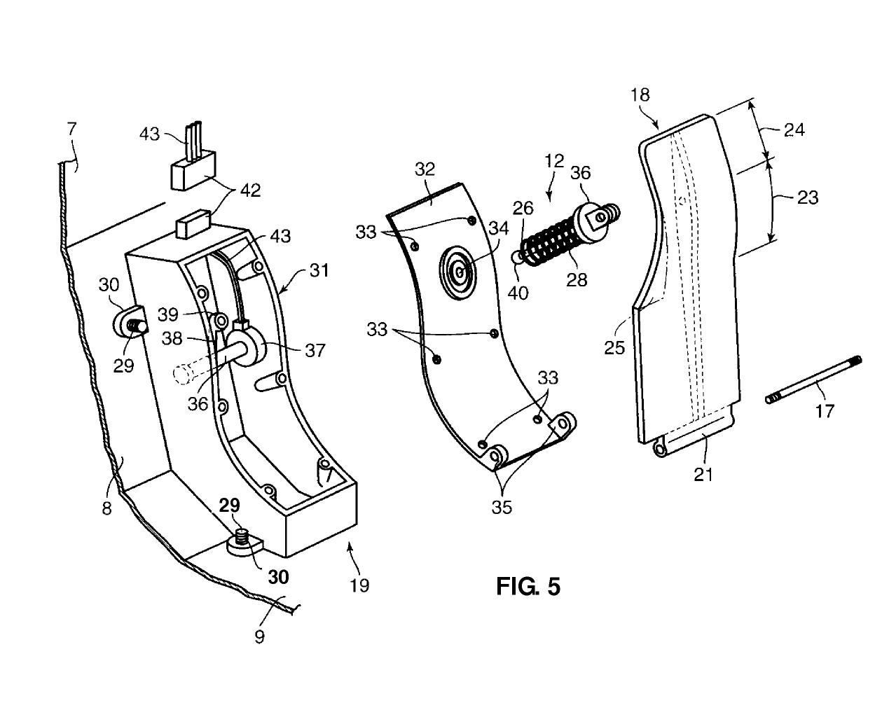

Herein, while the brake pedal 5 may be comprised of the so-called organ type of pedal, like the acceleration pedal 4, which has a lower-end pivotal portion and a pedal body pivotally supported at the lower-end pivotal portion, in case the so-called hanging type of brake pedal 5 which has the pedal body 46 pivotally supported at the upper-end pivotal portion 44 is applied as shown in FIG. 5, the brake pedal 5 can be supported stably with a simple structure and its operation can be kept in a proper state.

However, there is a tendency that as the pressing operational amount of the hanging type of brake pedal 5 increases, a locus of the ball of the pedal operational foot Bt or the like becomes different from a locus of the pressing operational portion 46a at the lower end portion of the pedal body 46, so that their contact point shifts improperly. Accordingly, for example, when the pedal pressing state is changed from a gentle braking operation state in which the pressing amount of the brake pedal 5 changes gently in a state in which the tall driver T places the heel Kt on the portion on the side of the driver's seat 15a of the slant floor portion 15 to a quick braking operation state in which the pressing amount increases greatly, that is, during a brake-pressing increase operation, the tall driver T may try to move the heel forwardly in accordance with the forward move of the pressing operational portion 46a of the brake pedal 5.

In this case, if the slant angle α2 of the portion on the side of the operational pedal 15b of the slant floor portion 15 is set to be about the same degree as the steep angle of the portion on the side of the operational pedal 15b, the smooth move may be hindered in case of moving the heel forwardly in order to keep the state of making the ball of the pedal operational foot contact the appropriate position of the pressing operational portion 46a. Meanwhile, in case the slant angle α2 of the portion on the side of the operational pedal 15b of the slant floor portion 15 is set to be smaller than that of the portion on the side of the operational pedal 15b like the first embodiment, the heel Kt of the driver can be made slide on the upper face of the portion on the side of the driver's seat 15a. Thereby, the brake-pressing increase operation of the brake pedal 5 can be conducted properly without making the driver have bad feelings.

In case the acceleration pedal 4 required to be operated delicately is comprised of the so-called organ type of pedal having the above-described pedal base portion 19 and the above-described pedal base 18 and the above-described slant floor portion 15 is provided, the delicate pedal operation of the acceleration pedal 4 can be conducted properly with a simple structure regardless of the body size of the driver seated in the driver's seat 1.

Further, since the interference avoidance portion comprised of the horizontal face portion 16 having the substantially flat horizontal upper face is provided in front of the slant floor portion 15 provided in the heel placement area on the floor panel 9 where the heel of the pedal operational foot is placed during the pressing operation of the acceleration pedal 4, it can be prevented effectively with a simple structure that the driver has the bad feelings which may be caused by the improper pressing of the driver's heel against the upper face of the slant floor portion 15 when the operation state is changed from the brake operation state in which the brake pedal 5 is pressed to the acceleration state in which the acceleration pedal 4 is pressed, for example. Accordingly, the proper pedal operation can be secured.

Herein, in place of the first embodiment in which, as shown in FIG. 3, the front portion of the floor mat 14 is placed on the horizontal face portion 16 formed at the front portion of the heel pad material 13, and the floor mat 14 is stably fixed onto the floor panel 9 in the state in which the front end face of the floor mat 14 contacts the positioning portion of the rear end portion of the pedal base portion 19, another structure in which the floor mat 14 is fixed to the layer material 11 of the floor carpet 12 in a state in which the front portion of the floor mat 14 is placed on the slant face portion, omitting the above-described horizontal face portion 16, may be considered.

However, in case of the above-described structure, the front portion of the floor mat 14 may easily slip down or be away from the slant face portion, so it may be difficult to support the floor mat 14 stably. According to the first embodiment, meanwhile, in which the front portion of the floor mat 14 is placed on the horizontal face portion 16 and the front end face of the floor mat 14 contacts the rear end portion of the pedal base portion 19 for positioning, the floor mat 14 can be stably fixed, without generating a situation where the front portion of the floor mat 14 gets away from the horizontal face portion 16 or the like.

Further, in case the interference avoidance portion comprised of the horizontal face portion 16 having the substantially-flat upper face is provided in front of the above-described slant floor portion 15, as shown by the phantom line in FIG. 15, there is provided a specified gap between the heel Ks of the shorter driver S placed on the front portion of the slant floor portion 15 and the pedal body 18 of the acceleration pedal 4 or the pedal base portion 19 supporting the pedal body 18. Accordingly, it can be properly prevented that the pedal operation is hindered by the heel Ks of the pedal operational foot at the pedal body 18 or the rear end portion of the pedal base portion 19 when the short driver S operates to press the acceleration pedal 4.

### Embodiment 2

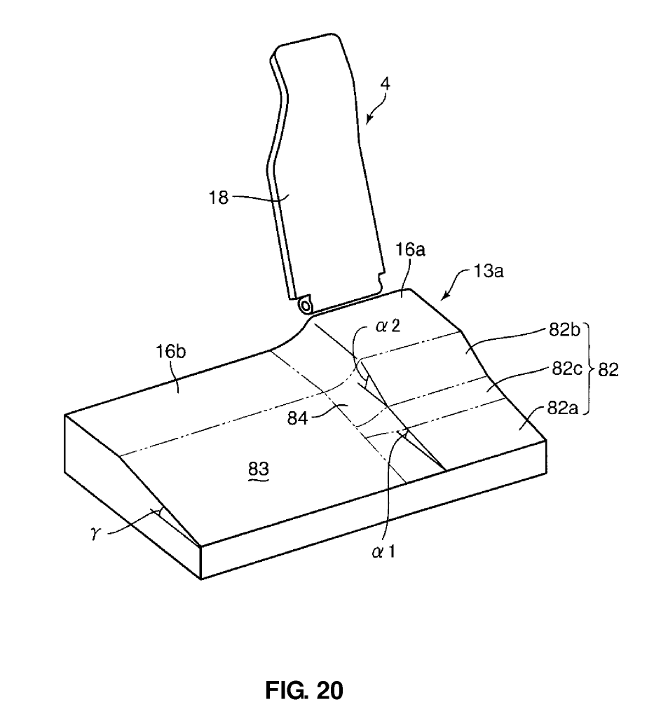

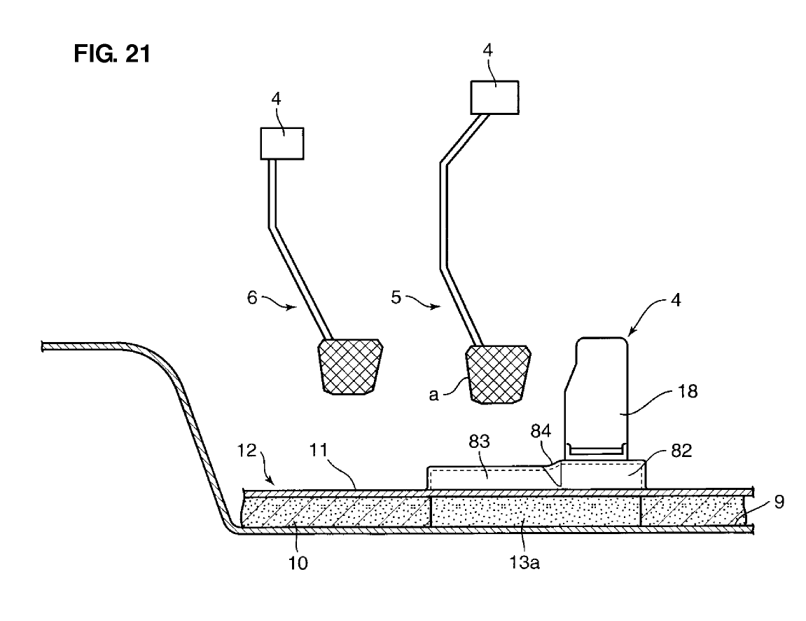

While the first embodiment in which the slant floor portion 15 which has the slant angles α1, α2 is provided in both of the heel placement areas for the acceleration pedal 4 and the brake pedal 5 is described above, a slant floor portion 82 for the acceleration pedal 4 (i.e., a first portion in claims) and a slant floor portion 83 for the brake pedal 5 (i.e., a second portion in claims) may be configured to have different slant angles from each other like a second embodiment shown in FIGS. 20 and 21.

That is, according to the second embodiment, the slant floor portion 82 positioned in the area on the side of the acceleration pedal comprises a portion on the side of the driver's seat 82a, a portion on the side of the operational pedal 82b, and a horizontal face portion 16a having a substantially-flat upper face, which are similar to the first embodiment. The slant angle α1 of the portion on the side of the driver's seat (rear side portion) 82a is set within the range of 5° to 15°, for example, and the slant angle α2 of the portion on the side of the operational pedal (front side portion) 82b is set within the range of 15° to 25° which is greater than the above-described slant angle α1, for example.

Meanwhile, the slant floor portion 83 positioned in the area on the side of the brake pedal comprises a constant slant angle γ which is set at the same angle as the slant angle α1 of the portion on the side of the driver's seat 82a for the acceleration pedal, i.e., within the range of 5° to 15°, and a horizontal face portion 16b having a substantially-flat upper face in front of the portion with the slant angle α1. Thus, the slant angle γ of the slant floor portion 83 positioned in the area on the side of the brake pedal is set to be smaller than the slant angle α2 of the portion on the side of the operational pedal 82b for the acceleration pedal.

Further, a level gap which is caused by a difference between the above-described angles α1, γ is formed between the slant floor portion 83 on the side of the brake pedal and the portion on the side of the driver's seat 82a of the slant floor portion 82 on the side of the acceleration pedal. Moreover, a connection portion 84 which smoothly interconnects the above-described slant floor portions 82, 83 is formed at the portion on the side of the operational pedal 82b.

In case the slant floor portions 82, 83 are provided in the heel placement portion on the floor panel 9 where the heel of the pedal operational foot of the driver's right foot during the operation of the acceleration pedal 4 and the brake pedal 5, and the slant angle γ of the slant floor portion 83 for the brake pedal is set to the angle smaller than the slant angle of the slant floor portion 82 for the acceleration pedal described above, the driver can operate to press the acceleration pedal 4 properly with the heel placed on the slant floor portion 82. Further, it can be effectively prevented that the driver has bad feeling, which may be caused the considerably-large resistance acting on the heel of the pedal operational foot during a pedal changing period from the operation state of the acceleration pedal 4 to the operation state of the brake pedal 5.

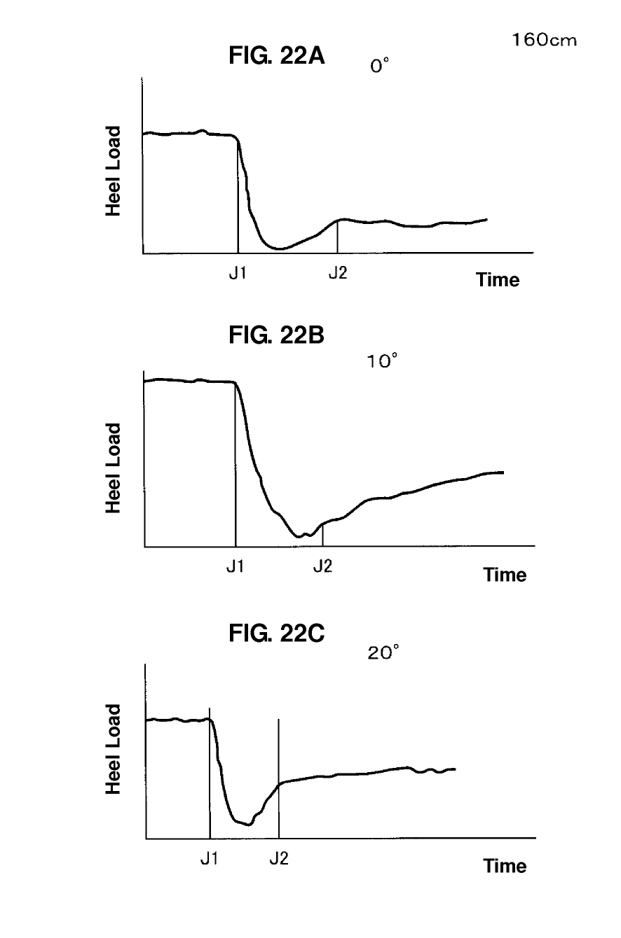

Herein, the simulation analyses of driver's operations from the operation state of the acceleration pedal 4 to the operation state of the brake pedal 5 were conducted for the cases of the above-described slant angle γ=0°, 10° and 20° and the drivers with the height of 160 cm, 170 cm and 180 cm. In the analyses, the load acting on the heel of the pedal operational foot, i.e., the operational resistance, was measured. Consequently, the data shown in FIGS. 22A, B, C-24A, B, C was obtained. In FIGS. 22A, B, C-24A, B, C, a point of J1 shows a timing when the pedal operational foot comes to be away from the acceleration pedal 4, and a point of J2 shows a timing when the pedal operational foot stats pressing the brake pedal 5.

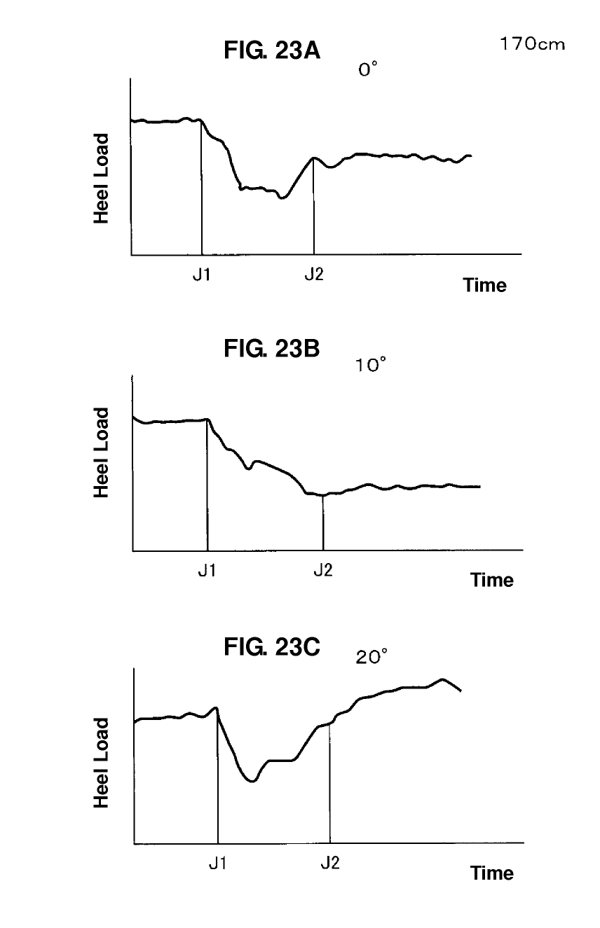

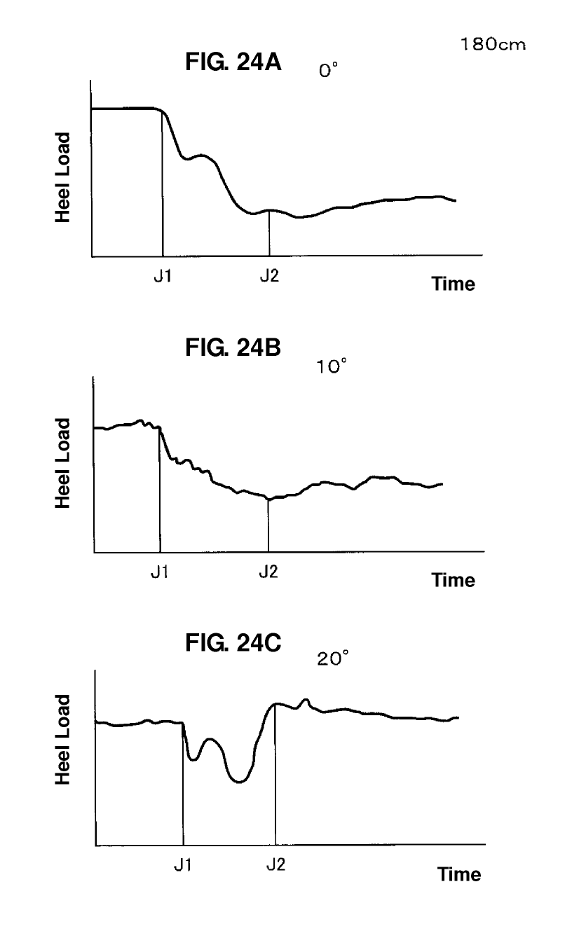

In case of the operation by the driver having the height of 160 cm, as shown in FIGS. 22A, B, C, the transitions to the operation state of the brake pedal 5 without any large operational resistance acting on the heel were verified. This is because this driver has the relatively-short sole's length, so the possibility of the heel being pressed against the floor surface strongly during the brake operation may be low. Meanwhile, in case of the operations by the drivers having the height of 170 cm or 180 cm, it was verified for the case of the slant angle 20° that a large load acted on the heel at the timing J2 when the operation was changed from the operation state of the acceleration pedal 4 to the operation state of the brake pedal 5 as shown in FIGS. 23C, 24C, and thereby the driver had bad feeling.

Meanwhile, in case the slant angle γ of the heel placement area on the side of the brake pedal 5 is set at 10°, as shown in FIGS. 23B, 24B, even if the operation state was changed from the operation state of the acceleration pedal 4 to the operation state of the brake pedal 5, it was verified that any large load did not act on the heel, so that the driver did not have bad feelings.

Accordingly, it is preferable that the slant angle γ of the slant floor portion 83 in the area on the side of the brake pedal be set to be smaller than the slant angle of the slant floor portion 82 in the area on the side of the acceleration pedal like the second embodiment in order to effectively prevent that the driver has bad feelings which may be caused by the large resistance acting on the heel of the pedal operational foot in the pedal changing period when the operation state is changed from the operation of the acceleration pedal 4 to the operation of the brake pedal, enabling any body-sized driver to conduct the proper pressing operation of the acceleration pedal 4 with the heel placed on the slant floor portion 82.

### Embodiment 3

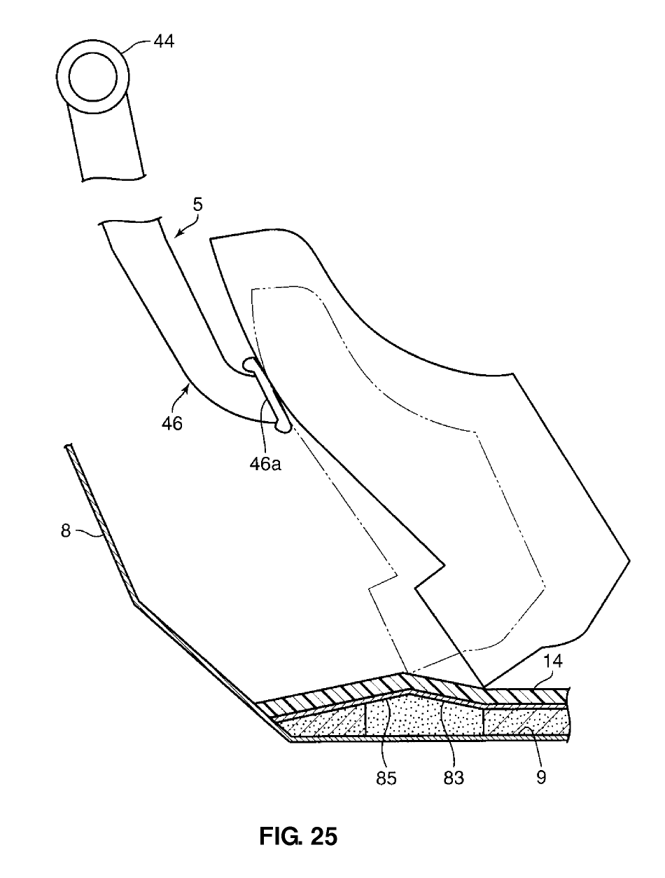

Further, another structure in which an interference avoidance portion 85, which is configured in such a manner that its front portion is positioned at a lower level than its rear portion, is provided in front of the above-described slant floor portion 83 or the like provided in the heel placement area on the floor panel 9 for the brake pedal 5 or the like, may be applied as shown as a third embodiment illustrated in FIG. 25. In this case with the interference avoidance portion 85 which has its upper face slanting downwardly at its front portion, it can be prevented more effectively that the driver has bad feeling, which may be caused by the driver's heel pressed against the floor surface strongly when the operation state is changed from the normal driving state of the driver's operating the acceleration pedal 4 to the quick braking state of the driver's promptly pressing the brake pedal 5.

Further, since the floor structure of the present embodiment further comprises the longitudinal-position adjusting mechanism 2 and the slant-angle adjusting mechanism 3, which moves the driver's seat 1 in the longitudinal direction and reduces the rearward slant angle of the seat cushion 1a of the driver's seat 1 in accordance with the forward move of the driver's seat 1, the longitudinal position of the driver's seat 1 and the slant angle of the seat cushion 1a is automatically adjusted so that the driver can keep its proper sitting position regardless of the body size, matching the driver's eye point to the appropriate line L, and get the superior handle and pedal operations.

Further, in case the sitting position of the driver seated in the driver's seat 1 or the like change in accordance with the operation of adjusting the longitudinal position of the driver's seat 1 and the slant angle of the seat cushion 1a, since the slant floor portion 15 is formed at the specified position on the floor panel 9 near the driver's foot, even the short driver S who has the shorter sole's length can conduct the pressing operation of the acceleration pedal 4 and the other properly in the state in which the heel's lower end Ks of the short driver S is placed on the slant floor portion 15 and the ball of the driver's foot Bs is made contact the appropriate position of the convex face portion 23 of the acceleration pedal 4 and the other, maintaining the proper angles of the ankle's angle θ1 and the sole's inclination angle θ7. Thus, the proper pedal operation and the like can be provided.

The present invention should not be limited to the above-descried embodiments, and any other modifications or improvements may be applied within the scope of a sprit of the present invention. For example, while the driver's seat 1 is automatically moved longitudinally by the longitudinal-position adjusting mechanism 2 according to the switch operation by the driver and the slant angle of the seat cushion 1a is reduced according to the forward move of the driver's seat 1 in the above-described embodiment, the longitudinal position of the driver's seat 1 and the slant angle of the seat cushion 1a may be adjusted with a manual operation of the driver.

What is claimed is:

1. A floor panel structure of a vehicle, in which a driver's seat is provided on a floor panel forming a bottom portion of a vehicle room and an operational pedal is provided in front of the driver's seat, comprising:
a slant floor portion provided in an area of the floor panel on which a heel of a foot of a driver pressing the operational pedal is placed, the slant floor portion slanting with a specified slant degree in such a manner that a front portion thereof is positioned at a higher level than a rear portion thereof; and
an interference avoidance portion provided in front of said slant floor portion, the interference avoidance portion having a slant degree which is smaller than said specified slant degree of the slant floor portion so as to avoid interference with the heel of the driver's foot.

2. The floor panel structure of a vehicle of claim 1, wherein said interference avoidance portion has a substantially-flat upper face.

3. The floor panel structure of a vehicle of claim 1, wherein said interference avoidance portion has an upper face which slants in such a manner that a front portion thereof is positioned at a lower level than a rear portion thereof.

4. The floor panel structure of a vehicle of claim 1, wherein said slant floor portion has a steeper slant area on the side of the operational pedal thereof than that on the side of the driver's seat thereof.

5. The floor panel structure of a vehicle of claim 4, wherein a slant angle of a portion on the side of the operational pedal of said slant floor portion is set within a range of 15° to 25°, and a slant angle of a portion on the side of the driver's seat of said slant floor portion is set within a range of 5° to 15°.

6. The floor panel structure of a vehicle of claim 4, wherein between a portion on the side of the driver's seat of said slant floor portion and a portion on the side of the operational pedal of said slant floor portion is provided a middle area where a slant angle increases gradually from an angle corresponding to a slant angle of the portion on the side of the driver's seat to an angle corresponding to another slant angle of the portion on the side of the operational pedal.

7. The floor panel structure of a vehicle of claim 1, wherein said operational pedal is an acceleration pedal which comprises a pedal base portion fixed to the floor panel and a pedal body pivotally supported at a pivotal portion which is formed at the pedal base portion.

8. The floor panel structure of a vehicle of claim 1, wherein said operational pedal is a brake pedal which comprises a pivotal portion provided at an upper portion thereof and a pressing operational portion pivotally supported at the pivotal portion.

9. The floor panel structure of a vehicle of claim 1, wherein said operational pedal comprises an acceleration pedal and a brake pedal which are provided side by side.

10. The floor panel structure of a vehicle of claim 9, wherein said slant floor portion comprises a first portion provided in the area of the floor panel on which the heel of the foot of the driver pressing the acceleration pedal is placed, and a second portion provided in the area of the floor panel on which the heel of the foot of the driver pressing the brake pedal is placed, the first portion having a steeper slant area on the side of the acceleration pedal than that on the side of the driver's seat thereof, and the second portion having an area with a constant slant which covers a substantially whole area thereof.

11. The floor panel structure of a vehicle of claim 10, wherein there is provided a connection portion which smoothly interconnects said first portion and said second portion.

12. A floor panel structure of a vehicle, in which a driver's seat is provided on a floor panel forming a bottom portion of a vehicle room, and an acceleration pedal and a brake pedal are provided side by side in front of the driver's seat, comprising:
a slant floor portion provided in an area of the floor panel on which a heel of a foot of a driver pressing the acceleration pedal and the brake pedal is placed, the slant floor portion slanting with a specified slant degree in such a manner that a front portion thereof is positioned at a higher level than a rear portion thereof, the slant floor portion having a steeper slant area on the side of the acceleration and brake pedals thereof than that on the side of the driver's seat thereof; and
an interference avoidance portion provided in front of said slant floor portion, the interference avoidance portion having a substantially-flat upper face.

13. The floor panel structure of a vehicle of claim 12, wherein a slant angle of a portion on the side of the acceleration and brake pedals of said slant floor portion is set within a range of 15° to 25°, and a slant angle of a portion on the side of the driver's seat of said slant floor portion is set within a range of 5° to 15°.

14. A floor panel structure of a vehicle, in which a driver's seat is provided on a floor panel forming a bottom portion of a vehicle room, and an acceleration pedal and a brake pedal are provided side by side in front of the driver's seat, comprising:
a slant floor portion provided in an area of the floor panel on which a heel of a foot of a driver pressing the acceleration pedal and the brake pedal is placed, the slant floor portion slanting with a specified slant degree in such a manner that a front portion thereof is positioned at a higher level than a rear portion thereof, and the slant floor portion comprising a first portion provided in the area of the floor panel on which the heel of the foot of the driver pressing the acceleration pedal is placed which has a steeper slant area on the side of the acceleration pedal than that on the side of the driver's seat thereof, and a second portion provided in the area of the floor panel on which the heel of the foot of the driver pressing the brake pedal is placed which has an area with a constant slant which covers a substantially whole area thereof; and
an interference avoidance portion provided in front of said slant floor portion for both the acceleration pedal and the brake pedal, the interference avoidance portion having a substantially-flat upper face.

15. The floor panel structure of a vehicle of claim 14, wherein a slant angle of a portion on the side of the acceleration pedal of said slant floor portion is set within a range of 15° to 25°, and a slant angle of a portion on the side of the driver's seat of said slant floor portion is set within a range of 5° to 15°.
